(19) United States
(12) Patent Application Publication
(10) Pub. No.: US 2014/0224553 A1
(43) Pub. Date: Aug. 14, 2014

(54) LOAD MEASUREMENT SENSOR SUPPORT STRUCTURE

(71) Applicant: Hidetoshi Ozawa, Tochigi (JP)

(72) Inventor: Hidetoshi Ozawa, Tochigi (JP)

(73) Assignee: TS TECH CO., LTD., Asaka-shi, Saitama (JP)

(21) Appl. No.: 14/237,739

(22) PCT Filed: Aug. 9, 2012
(86) PCT No.: PCT/JP2012/070342

§ 371 Date: Apr. 22, 2014

(30) Foreign Application Priority Data
Aug. 10, 2011 (JP) 2011-175459
Jun. 8, 2012 (JP) 2012-131052

(51) Int. Cl. G01G 19/08

(52) U.S. Cl. CPC G01G 19/08
USPC 177/136

(57) ABSTRACT

In a case where a load measurement sensor is supported so that an extension shaft portion is located at the lateral side of a sensor body, the load measurement sensor is stably disposed without interference with the other members and an increase in the size of a seat is suppressed. In a support structure that supports a load measurement sensor by a height adjustment mechanism so that an extension shaft portion of the load measurement sensor is located at the lateral side of a sensor body, the height adjustment mechanism is a mechanism that displaces the height of a side frame with respect to an attachment member through the link mechanism including link members connecting the side frame to the attachment member, and the load measurement sensor is disposed so that at least a part of a load receiving portion of the sensor body is disposed in the link mechanism.

### CROSS-REFERENCE TO RELATED APPLICATIONS

This application is the U.S. national phase of the International Patent Application No. PCT/JP2012/070342, filed Aug. 9, 2012, which claims the benefit of Japanese Patent Application Nos. 2011-175459, filed Aug. 10, 2011, and 2012-131052, filed Jun. 8, 2012, the contents of both being incorporated herein in their entirety.

### BACKGROUND

Disclosed herein is a support structure that supports a load measurement sensor by a height adjustment mechanism for adjusting the height of a seat, and particularly, a support structure that supports a load measurement sensor while an extension shaft portion provided in a load measurement sensor is located at the lateral side of a sensor body.

For the purpose of improving the safety or the comfortable sitting feeling of a passenger, there has been proposed a technique that controls the operation of a peripheral member of a vehicle seat in response to the weight of the passenger sitting on the vehicle seat. In such a technique, a load measurement sensor is generally disposed below the vehicle seat on which the passenger sits in order to detect the weight of the passenger sitting on the vehicle seat.

As for the load measurement sensor arrangement position, the load measurement sensor is generally disposed below the vehicle seat. For example, there is known a vehicle seat in which a load measurement sensor is disposed between a slide rail that slides the vehicle seat in the front to back direction and a seat frame that constitutes the vehicle seat.

As such a configuration, there is known, for example, a configuration in which a load measurement sensor is installed above an upper rail sliding on a lower rail attached to a vehicle body floor and a seat frame is disposed above the load measurement sensor.

Then, in the load measurement sensor with such a configuration, a so-called “perpendicular-axis-type” load measurement sensor is used in many cases.

The perpendicular-axis-type load measurement sensor includes a shaft portion that is fixed to the seat frame, and is disposed so that the axial direction of the shaft portion becomes the perpendicular direction.

In recent years, there has been a demand for a technique of decreasing the height of a vehicle seat in order to improve the convenience of the passenger when the passenger sits on the vehicle seat or to improve the design of the vehicle seat. In a case where the above-described “perpendicular-axis-type” load measurement sensor is installed, the seat frame is disposed at a high position by the height of the load measurement sensor, and hence a problem arises in that the height of the vehicle seat increases.

In order to solve the above-described problems, there is proposed a technique in which the load measurement sensor is installed so that the axial direction of the shaft portion extending from a sensor body becomes the horizontal direction instead of the perpendicular direction (for example, see Japanese Patent Document No. 2010-042809 A, “the '809 Document”). In the '809 Document, since the load measurement sensor (which is described as a “body weight detection sensor” in this document) is supported so that the axial direction of the extension shaft portion becomes the horizontal direction and the load measurement sensor is disposed to be included in the height range of the seat frame, the height of the vehicle seat may be further decreased by the technique of the '809 Document.

The recent vehicle seat includes a height adjustment mechanism in many cases.

That is, there is known a vehicle seat having a height adjustment function of adjusting the height of the vehicle seat in response to the body shape of the passenger so that a steering performance is ensured in a driver seat and a comfortable sitting feeling is ensured in the other seats in consideration of each of different body shapes of the passengers (for example, see Japanese Patent Document No. 2007-308050 A, “the '050 Document”).

The '050 Document discloses a technique of adjusting the height of the vehicle seat using a link mechanism.

The link mechanism disclosed in '050 Document mainly includes a front link, a back link, and a connection member that connects the front and back links to each other.

In the front link and the back link, the lower ends thereof are rotatably fixed to the upper rail and the upper ends thereof rotatably journaled to both ends of the longitudinal connection member.

Further, the substantial center portions of the front link and the back link are rotatably fixed to a plate surface of a cushion side frame.

Further, a rotational force that is generated by the operation of a knob is transmitted to a rotation shaft of the upper end of the front link through a pinion gear and a sector gear.

With such a configuration, for example, when the operation knob is rotated in a case where the seat height is low, the pinion gear rotates in the counter-clockwise direction and the sector gear engaging with the pinion gear rotates in the clockwise direction. Accordingly, the rotation shaft of the upper end of the front link rotates, and hence the front link pivots in an ascending direction. Then, the front end of the back link that is connected (bridged) to the front link by the longitudinal connection member is drawn toward the front side of the vehicle with this movement to ascend. As a result, the vehicle seat increases in height.

However, in a case where the load measurement sensor is supported so that the axial direction of the extension shaft portion follows the horizontal direction, the support space is widened in the horizontal direction, and hence the load measurement sensor easily interferes with the other member in the horizontal direction. Such a problem may noticeably occur in a case where the load measurement sensor is attached to the inner position of the seat. For example, in a case where the height adjustment mechanism disclosed in '050 Document is provided, various members such as a link member are disposed to operate such a mechanism, and hence a load measurement sensor support structure is needed which prevents the interference between such a member and the load measurement sensor.

In other words, when the height adjustment mechanism using the parallel link disclosed in '050 Document is mounted on the seat that uses the horizontal-axis-type load measurement sensor, a problem arises in that the seat inevitably increases in size to suppress the interference between the installed load measurement sensor and the height adjustment mechanism. For this reason, there has been a strong desire for the support structure capable of supporting the load measurement sensor without any interference with the height adjustment mechanism and preventing an increase in the size of the seat.

In some load measurement sensors, a deformation portion that is deformed by a load is provided as a detection portion for detecting the load. This kind of load measurement sensor measures the load based on the deformation amount when the deformation portion is deformed by the load transmitted from the seat. However, in the load measurement sensor, when a biased load is applied to the load measurement sensor due to the influence of the sitting posture or the sitting position of the passenger, the deformation portion may be excessively deformed. In such a state, there is a concern that the normal load measurement may not be performed.

### SUMMARY

Therefore, various embodiments of the present invention are described herein, in view of the above-described problems, and an object thereof is to realize a support structure capable of stably supporting the load measurement sensor without any interference with the member other than the load measurement sensor, that is, the member constituting the height adjustment mechanism while suppressing an increase in the size of the seat in a case where the load measurement sensor is supported so that the extension shaft portion is located at the lateral side of the sensor body.

Further, another object is to realize a support structure capable of accurately detecting the load input from the seat by reliably transmitting the input load to the deformation portion of the load measurement sensor.

According to various embodiments, the above-described problems are solved by a load measurement sensor support structure that supports a load measurement sensor, including a sensor body detecting a load applied to a seat and an extension shaft portion extending from the lateral side of the sensor body, by a height adjustment mechanism for adjusting the height of the seat while the extension shaft portion is located at the lateral side of the sensor body, wherein the seat includes a skeleton, which includes a plurality of side frames disposed to be separated from each other in the vehicle width direction and a plurality of connection members connecting the front and back sides of the side frames of a vehicle, and is connected to a plurality of attachment members provided below the plurality of side frames, wherein the height adjustment mechanism includes a link mechanism that connects the side frame to the attachment member and displaces the height of the side frame with respect to the attachment member through the link mechanism, and wherein the load measurement sensor is supported so that at least a part of a load receiving portion of the sensor body is disposed in the link mechanism.

In the support structure, since the load measurement sensor may be assembled in the existing height adjustment mechanism, the interference between the load measurement sensor and the seat inner member is suppressed. For this reason, the seat may be decreased in size without any problem, and hence an increase in the size of the seat may be suppressed.

In addition, in the support structure, as in an embodiment, the load measurement sensor may be disposed to be rotatable relative to the link mechanism. According to such a configuration, even when the link mechanism as the parallel link is displaced, the attachment angle of the load measurement sensor is not displaced. As a result, the accurate load detection may be performed.

Further, in the support structure, as in an embodiment, when the load measurement sensor is disposed at an insertion hole located on a rotation center of a link member constituting the link mechanism and the load receiving portion is disposed at the insertion hole located on the rotation center, the above-described effect may be further appropriately exhibited. According to such a configuration, since the load measurement sensor may be inserted into the rotation shaft insertion hole, there is no need to adopt a new sensor support member. Further, since the load measurement sensor may be assembled in the existing rotation shaft insertion hole, the interference between the load measurement sensor and the seat inner member is effectively suppressed. As a result, the seat may be further decreased in size.

Further, since the load measurement sensor may be disposed at the rotation shaft insertion hole of the link member instead of the rotation shaft, the link member rotates about the load measurement sensor (that is, the load measurement sensor may rotate with respect to the link member as the opposite concept). Thus, even when the link member is displaced due to the rotation, the angle of the load measurement sensor is not displaced, and hence the accurate load measurement may be performed.

Further, in the support structure, specifically, as in an embodiment, the link mechanism may include the attachment members and the link members rotatably journaled to the side frames, the load measurement sensor may be disposed at an insertion hole which is located on a first rotation center and into which a rotation shaft journaled to the link member to rotate the link member with respect to the attachment member is inserted, and the load receiving portion may be disposed at the insertion hole located on the first rotation center.

Alternatively, as in an embodiment, the link mechanism may include the attachment members and the link members rotatably journaled to the side frames, the load measurement sensor may be disposed at an insertion hole which is located on a second rotation center and into which a rotation shaft journaled to the link member to rotate the link member with respect to the attachment member is inserted, and the load receiving portion may be disposed at the insertion hole located on the second rotation center.

When any configuration is employed from the configurations illustrated in above described embodiments, the load measurement sensor may be efficiently assembled to the height adjustment mechanism.

Further, when the load measurement sensor is supported by the side frame or the like, the support rigidity for the load measurement sensor is improved by the rigidity of the side frame as the support member.

Further, in the support structure, more specifically, as in an embodiment, the link mechanism may include a front link member that is rotatably journaled to the attachment member and the side frame at the front side of the vehicle and a back link member that is rotatably journaled to the attachment member and the side frame at the back side of the vehicle, and at least one of the front link member and the back link member may be formed as a curved member that includes a lower end piece which is rotatably connected to the attachment member and extends toward the upper side of the vehicle, a center portion connection piece which extends in a curved state from the lower end piece toward the upper side of the vehicle in the vehicle width direction, and an upper end piece which extends from the center portion connection piece toward the upper side of the vehicle. According to such a configuration, the rigidity of the link member may be appropriately improved.

Further, in the support structure, as in an embodiment, the link mechanism may include the attachment members and the link members rotatably journaled to the side frames, and the side frame may be formed as a curved member that includes a lower end wall which is rotatably connected to the upper end of the link member and extends toward the upper side of the vehicle, a center portion connection wall which extends in a curved state from the lower end wall toward the upper side of the vehicle in the vehicle width direction, and an upper end wall which extends from the center portion connection wall toward the upper side of the vehicle. According to such a configuration, the rigidity of the side frame may be appropriately improved.

Further, in the support structure of an embodiment, the center portion connection wall may extend in a curved state from the lower end wall outward and upward in the vehicle width direction, and the lower end wall may be disposed at the inner side of the vehicle in relation to the upper end wall. According to such a configuration, it is possible to effectively suppress the sensor body of the load measurement sensor or the vehicle outer side end (which is a portion that protrudes toward the outer side of the vehicle and is fastened by the nut) of the extension shaft portion from protruding outward in the seat width direction, and to protect the portion by the concave portion formed by the lower end wall and the center portion connection wall.

Further, in the support structure, as in an embodiment, the link member constituting the link mechanism may be provided below the side frame and be disposed at the inner side of the vehicle in relation to a center line extending in the front to back direction of the vehicle of a rail member connected with the attachment member. According to such a configuration, since the load measurement sensor may be disposed at the inner side of the rail member, it is possible to effectively suppress the load measurement sensor from protruding toward the outer side of the seat.

Further, in the above-described configuration, as in an embodiment, the axis of the connection member and the axis of the extension shaft portion may be disposed at different positions. According to such a configuration, it is possible to effectively suppress the interference between the load measurement sensor and the connection member.

Further, in the above-described configuration, as in an embodiment, the link member constituting the link mechanism may be provided with the plurality of insertion holes, the load measurement sensor may be disposed at one of the plurality of insertion holes, and in the plurality of insertion holes, the diameter of the insertion hole in which the load measurement sensor is disposed may be set to be different from the diameter of the insertion hole which is located on the rotation center and in which the load measurement sensor is not disposed. According to such a configuration, when it is possible to simply recognize the arrangement hole when the load sensor is disposed, and hence to effectively prevent the erroneous assembly.

Further, in the above-described configuration, as in an embodiment, the sensor body may include a deformation portion that receives the load at the load receiving portion to be bent inward in the radial direction of the extension shaft portion, the load measurement sensor support structure includes: a load input portion that inputs the load to the load measurement sensor while contacting the load measurement sensor; and a sensor body receiving portion that presses the load receiving portion when the load measurement sensor is moved by the load input from the load input portion, the sensor body receiving portion may be disposed on the insertion hole located on the rotation center of the link member constituting the link mechanism, the deformation portion may be disposed at the insertion hole to face the sensor body receiving portion, and in a state where the deformation portion is disposed at the insertion hole, the load input portion may be separated from the sensor body receiving portion. According to such a structure, the load input portion and the sensor body receiving portion are separated from each other. For this reason, when the load is input from the load input portion to the load measurement sensor, the load measurement sensor move, and the load receiving portion formed in the deformation portion is deformed while being pressed against the sensor body receiving portion with this movement. Accordingly, the load input from the load input portion is reliably transmitted to the deformation portion of the sensor body. Further, even when the input load is minute, the load is appropriately transmitted from the load input portion to the deformation portion by the principle of the lever. As a result, the load input from the load input portion may be appropriately transmitted to the deformation portion, and hence the load may be accurately detected.

According to an embodiment, since the load measurement sensor may be mounted on the existing height adjustment mechanism, the interference between the load measurement sensor and the seat inner member is suppressed, and the seat may be decreased in size without any problem. Thus, an increase in the size of the seat may be suppressed.

According to an embodiment, since the attachment angle of the load measurement sensor is not displaced even when the link mechanism as the parallel link is displaced, the accurate load detection may be performed.

According to an embodiment, the interference between the load measurement sensor and the seat inner member is effectively suppressed, and hence the seat may be further decreased in size.

According to an embodiment, the load measurement sensor may be efficiently assembled to the height adjustment mechanism, and hence a decrease in the size of the seat may be further realized.

Further, since the load measurement sensor is attached to the side frame or the like, the attachment rigidity for the load measurement sensor is improved by the rigidity of the support member.

According to an embodiment, the rigidity of the link member is improved. For this reason, the support rigidity for the load measurement sensor is improved, and hence the accurate sensing is realized.

According to an embodiment, the rigidity of the side frame is improved. For this reason, the support rigidity for the load measurement sensor is improved, and hence the accurate sensing is realized.

According to an embodiment, it is possible to improve the rigidity of the link member, and to effectively suppress the sensor body of the load measurement sensor or the vehicle outer side end (which is a portion that protrudes toward the outer side of the vehicle and is fastened by the nut) of the extension shaft portion from protruding outward in the seat width direction.

According to an embodiment, it is possible to improve the rigidity of the side frame, and to effectively suppress the sensor body of the load measurement sensor or the vehicle outer side end (which is a portion that protrudes toward the outer side of the vehicle and is fastened by the nut) of the extension shaft portion from protruding outward in the seat width direction.

According to an embodiment, it is possible to further reliably protect the sensor body of the load measurement sensor or the fastening portion of the load measurement sensor protruding toward the outer side of the vehicle in addition to the effects described above.

According to an embodiment, it is possible to further reliably protect the sensor body of the load measurement sensor or the fastening portion of the load measurement sensor protruding toward the outer side of the vehicle in addition to the effects described above.

According to an embodiment, the load input from the load input portion is reliably transmitted to the deformation portion of the sensor body. Further, even when the input load is minute, the load is appropriately transmitted from the load input portion to the deformation portion by the principle of the lever. As a result, the load input from the load input portion may be appropriately transmitted to the deformation portion, and hence the load may be accurately detected.

### BRIEF DESCRIPTION OF THE DRAWINGS

Various embodiments of the invention are illustrated in the drawings, as described below:

FIG. 1 is an external perspective view of a vehicle seat according to an embodiment;

FIG. 2 is a perspective view of a seat frame according to the embodiment;

FIG. 3 is a perspective view of a driving-side link that constitutes a link mechanism according to the embodiment;

FIG. 4 is a side view of the driving-side link according to the embodiment;

FIG. 5 is a perspective view illustrating an attachment state of a track regulation member according to the embodiment;

FIGS. 6A-C are explanatory side views illustrating states where a vehicle seat is moved up and down by the link mechanism according to the embodiment;

FIG. 7 is a front partial sectional view illustrating a load measurement sensor support structure according to the embodiment;

FIG. 8 is an exploded component view illustrating sensor attachment components according to the embodiment;

FIG. 9 is an enlarged sectional side view illustrating the periphery of the load measurement sensor of FIG. 7;

FIG. 10 is an explanatory front partial sectional view illustrating Embodiment 1 of the load measurement sensor support structure according to the embodiment;

FIG. 11 is an explanatory front partial sectional view illustrating Embodiment 2 of the load measurement sensor support structure according to the embodiment;

FIG. 12 is an explanatory front partial sectional view illustrating Embodiment 3 of the load measurement sensor support structure according to the embodiment;

FIG. 13 is an explanatory front partial sectional view illustrating Embodiment 4 of the load measurement sensor support structure according to the embodiment;

FIG. 14 is an explanatory front partial sectional view illustrating Embodiment 5 of the load measurement sensor support structure according to the embodiment;

FIG. 15 is an explanatory front partial sectional view illustrating Embodiment 6 of the load measurement sensor support structure according to the embodiment;

FIG. 16 is an explanatory front partial sectional view illustrating Embodiment 7 of the load measurement sensor support structure according to the embodiment;

FIG. 17 is a partially enlarged side sectional view of the load measurement sensor support structure illustrated in FIG. 16;

FIG. 18 is a side sectional view illustrating a state of the load measurement sensor of Embodiment 7 in the event of a load;

FIG. 19 is a side sectional view illustrating a first modified example of the load measurement sensor support structure of Embodiment 7; and

FIG. 20 is a side sectional view illustrating a second modified example of the load measurement sensor support structure of Embodiment 7.

### DETAILED DESCRIPTION

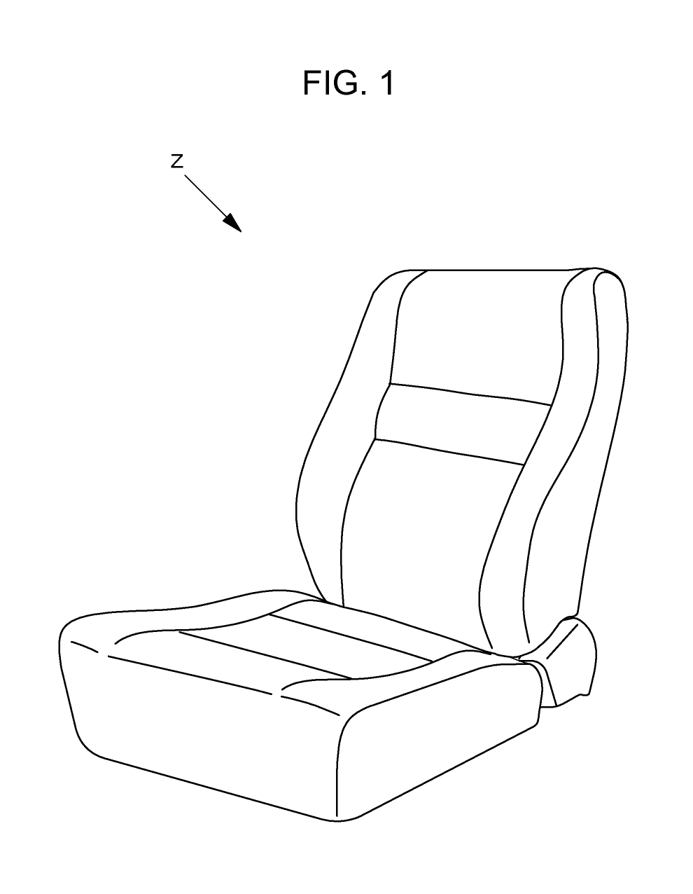

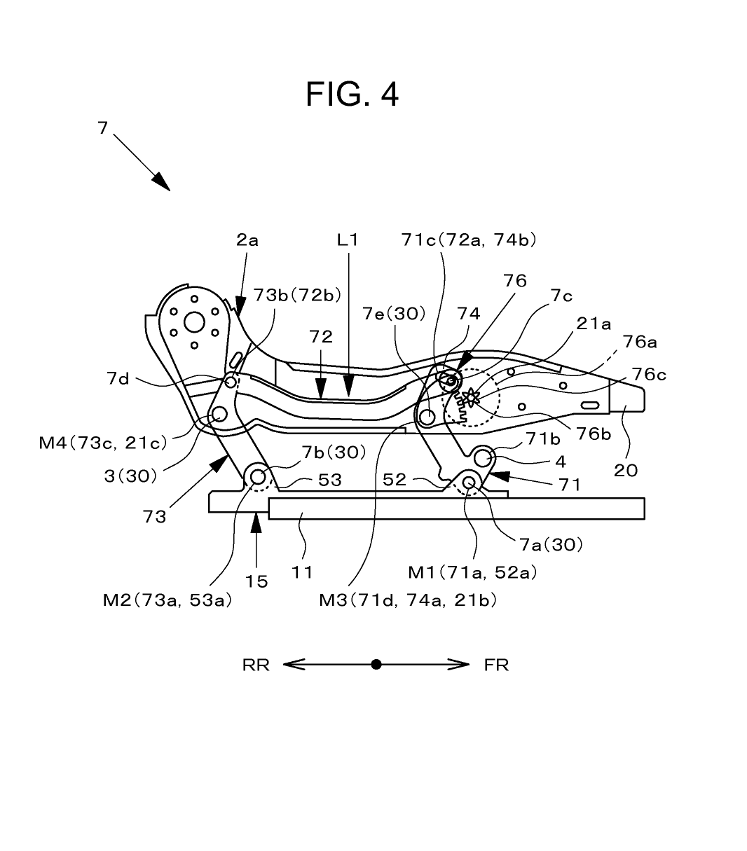

Hereinafter, a load measurement sensor support structure according to an embodiment of the present invention will be described with reference to FIGS. 1 to 20.

A load measurement sensor of this embodiment is used to measure a load applied to a vehicle seat, that is, a load generated when a passenger sits on the vehicle seat. In the description below, in the vehicle seat including a height adjustment mechanism, a support structure that supports the load measurement sensor at a predetermined position in a predetermined posture will be described.

First, the vehicle seat, the load measurement sensor, the height adjustment mechanism, and the operation of the vehicle seat using the mechanism will be described, and the specific structure for supporting the load measurement sensor by the height adjustment mechanism will be described in Embodiments (Embodiments 1 to 7) below.

Furthermore, the sign FR of the views indicate the front side of the vehicle, and the sign RR indicates the back (rear) side of the vehicle. Further, in the description below, the width direction of the vehicle seat Z (hereinafter, referred to as the seat width direction or the width direction) indicates a direction that matches the vehicle width direction, indicates the right and left direction when a passenger faces the front side of the vehicle, and corresponds to the horizontal direction.

In this embodiment, the load measurement sensor (hereinafter, a sensor 30) is used to measure a load generated when the passenger sits on the vehicle seat Z as described above. The measurement result is output as an electric signal from the sensor 30 (specifically, a circuit board in a circuit board unit provided in a sensor body 32), and the output signal is received by a receiver (not illustrated). Subsequently, it is determined whether the passenger sits on the vehicle seat Z or the sitting passenger is an adult or a child based on the received output signal. Then, the determination result is used as, for example, data for controlling the expansion of an air-bag unit in the event of the collision of the vehicle.

From the above-described purpose, the sensor 30 is assembled to a predetermined position of a seat unit S.

### Structure of Vehicle Seat

First, the structure of the seat unit S including the vehicle seat Z will be described.

Furthermore, since the vehicle seat Z is the same as the existing vehicle seat except for the support position and the support mechanism of the sensor 30, the vehicle seat will be simply described.

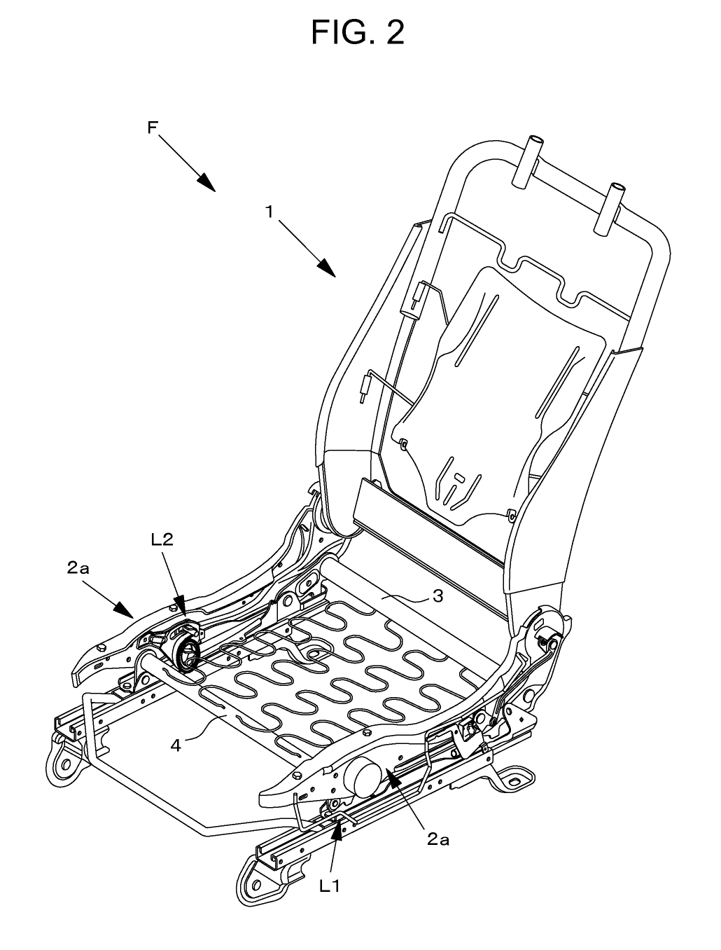

The seat unit S is fixed to a vehicle body floor, and mainly includes the vehicle seat Z, a rail mechanism 10, and a height adjustment mechanism 7. The vehicle seat Z illustrated in FIG. 1 is an example of the seat, and includes a seat frame F and a cushion member as skeletons illustrated in FIG. 2. The seat frame F is formed of metal, and includes a seating frame 2 of which each of both ends in the right and left direction is provided with a side frame 2a and a seat back frame 1 which is provided at the back side. Further, the seat frame F includes a front connection pipe 4 and a back connection pipe 3 as a plurality of connection members.

As illustrated in FIGS. 2 to 5, each of the side frames 2a constituting the seating frame 2 is a sheet-metal member that extends in the front to back direction, and is connected to the seat back frame 1 at the back end thereof. Further, the side frame 2a at one end side (the left side) in the right and left direction and the side frame 2a at the other end side (the right side) in the right and left direction are separated from each other in the right and left direction to be parallel to each other. The back ends of the side frames 2a are connected to each other through the back connection pipe 3 rotatably journaled to a driving-side link mechanism L1 and a driven-side link mechanism L2, and the front ends thereof are connected to each other through the front connection pipe 4.

Each of the front connection pipe 4 and the back connection pipe 3 is a pipe member that extends from one end of the vehicle seat Z in the width direction to the other end thereof.

Although it will be described later, both ends of the front connection pipe 4 and the back connection pipe 3 are rotatably journaled to the driving-side link mechanism L1 and the driven-side link mechanism L2 (constituting the height adjustment mechanism 7) to be described later.

That is, the front connection pipe 4 is journaled to the driving-side link L1 and the driven-side link L2 at the front side of the vehicle, and the side frames 2a and 2a as both sides are bridged at the front side of the vehicle through the driving-side link L1 and the driven-side link L2.

Further, the back connection pipe 3 is journaled to the driving-side link L1 and the driven-side link L2 at the back side of the vehicle, and the side frames 2a and 2a as both sides are bridged at the back side of the vehicle through the driving-side link L1 and the driven-side link L2.

The attachment structure of the driving-side link L1 and the driven-side link L2 will be described in detail in the description of the height adjustment mechanism 7.

Further, a plurality of (four in the case illustrated in FIG. 2) S-springs 6 are disposed between the side frames 2a. Each of the S-springs 6 is a support spring that supports a cushion member from the lower side thereof, and extends in the front to back direction in a meandering state.

Furthermore, the method of bridging the S-springs 6 is not particularly limited, and an existing bridging method may be used. However, for example, each of the S-springs may be disposed between the side frames 2a so that the front end thereof is hung by an installation pan (not illustrated) installed between the side frames 2a and the back end thereof is hung by the back connection pipe 3 (more specifically, a substantially circular-arc latching member (not illustrated) fitted to the connection pipe). Then, in this embodiment, the cushion member is mounted on the installation pan and the S-spring 6.

The structure of the side frame 2a will be described. The side frame 2a is formed by processing an elongated sheet metal, and the front end 20 is bent inward to define the front end of the vehicle seat Z. Further, two circular hole portions are provided at the slightly back side of the front end of the side frame 2a and one circular hole portion is provided at the slight front side of the back end so that the rotation shafts disposed in the height adjustment mechanism 7 penetrate the circular hole portions.

The circular hole portions are referred to as a “first shaft penetration hole 21a”, a “second shaft penetration hole 21b”, and a “third shaft penetration hole 21c (which are not depicted later as the penetration holes) in order from the front side of the vehicle.

A shaft constituting the link mechanism L penetrates the “first shaft penetration hole 21a”, the “second shaft penetration hole 21b”, and the “third shaft penetration hole 21c”.

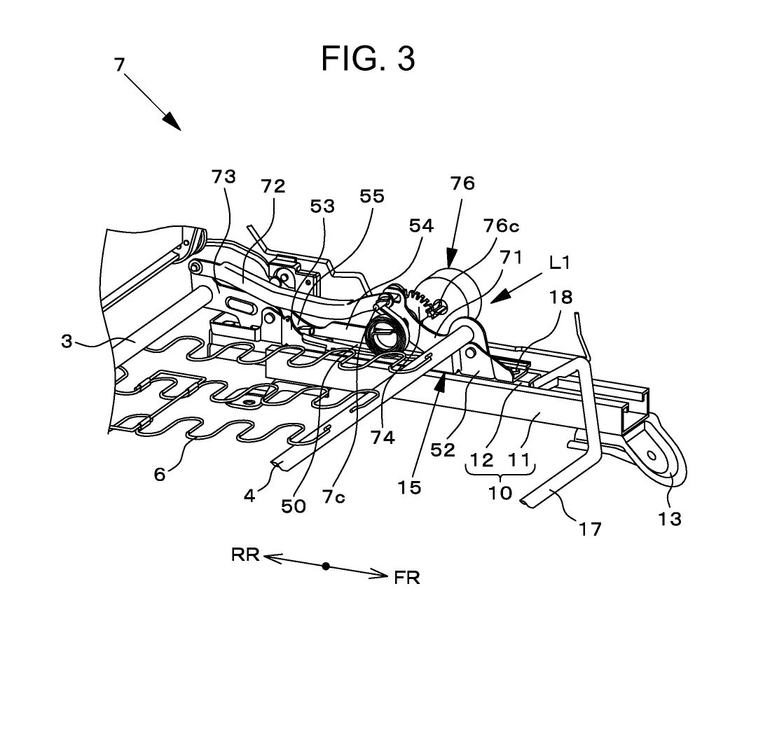

As illustrated in FIGS. 2 and 3, the rail mechanism 10 is provided as a pair of rail mechanisms, and one (left) rail mechanism 10 and the other (right) rail mechanism 10 are separated from each other in the right and left direction to be parallel to each other. Each rail mechanism 10 includes a lower rail 11 that is fixed to the vehicle body floor and an upper rail 12 that is slidable on the lower rail 11 while engaging with the lower rail 11.

Each of the lower rail 11 and the upper rail 12 is provided as a pair of lower rails and a pair of upper rails, and extends in the front to back direction. The pair of upper rails 12 is disposed in parallel with a gap therebetween in the width direction, and both rails 12 are connected to each other by a slide lever 17.

As illustrated in FIG. 2, the pair of lower rails 11 is disposed in parallel with a gap therebetween in the right and left direction, and the lower rails 11 are connected to each other by a member frame (not illustrated). Further, a support bracket 13 is attached to the lower surface of each lower rail 11. When the support bracket 13 is fastened to the vehicle body floor, the lower rail 11 is fixed to the vehicle body floor.

Then, the vehicle seat Z is placed on the lower rails 11 through the height adjustment mechanism 7. More specifically, the upper rail 12 is disposed on the lower rail 11 in a slidable manner, and an attachment bracket 15 as an attachment member is fixed onto the upper rail 12 by a bolt 18 and a nut as fastening members. The height adjustment mechanism 7 is attached to the attachment bracket 15, and the side frame 2a of the vehicle seat Z is connected to the height adjustment mechanism 7. Accordingly, the vehicle seat Z is connected to each of the upper rails 12 to be movable in the front to back direction and the up to down direction.

Furthermore, in a state where the vehicle seat Z is connected to each of the lower rails 11 through the height adjustment mechanism 7, the side frame 2a at one end side (left side) of the right and left direction is located above the lower rail 11 at one end side (left side) of the right and left direction, and the side frame 2a at the other end side (right side) of the right and left direction is located above the lower rail 11 at the other end side (right side) of the right and left direction. Further, in a state where the vehicle seat Z is placed on each of the lower rails 11 through the height adjustment mechanism 7, the plurality of S-springs 6 are located between the lower rails 11 while being disposed in parallel in the right and left direction.

### Height Adjustment Mechanism

Subsequently, the height adjustment mechanism 7 according to this embodiment will be described with reference to FIGS. 3 to 6.

Furthermore, in the description below, for convenience of the description, the other side of the pair of rail members (for example, the lower rails 11) when viewed from one side thereof is referred to as the inner side, and the opposite side to the other side is referred to as the outer side. Further, in a case when one end side and the other end side of the width direction have a common configuration like the bilaterally symmetrical configuration, only the configuration at one end side of the width direction of the vehicle seat Z will be described.

Furthermore, an example of using a general shaft will be described for the description of the operation of the height adjustment mechanism 7.

That is, as described herein, the shaft of the parallel link is appropriately substituted by the sensor 30, but in the configuration. However, in the description below, a configuration of using the shaft of the general parallel link will be described in the description of Embodiments 1 to 7.

The height adjustment mechanism 7 according to this embodiment includes the attachment bracket 15 that is used for the attachment of two links and the driving-side link L1 and the driven-side link L2 that are respectively attached thereto.

The attachment bracket 15 according to this embodiment is formed as a member separately from the upper rail 12, extends in the front to back direction of the vehicle seat Z, and is removably fixed to the upper surface of the upper rail 12 by a bolt 18. In this way, since the attachment brackets 15 and 15 used for the attachment of the driving-side link L1 and the driven-side link L2 are formed as members separated from the upper rails 12, the sensor 30 may be reset even when the seat design is changed. Accordingly, the general versatility of the support structure for the sensor 30 is improved, and the maintenance workability is also improved.

In this embodiment, the attachment bracket 15 is attached to each of two upper rail 12 to follow the front to back direction of the vehicle seat Z. Then, the driving-side link mechanism L1 and the driven-side link mechanism L2 are respectively attached to the attachment brackets 15.

As illustrated in FIGS. 2, 3, and 5, the attachment bracket 15 is formed in a substantially U-shape in the front view (when viewed from the front side), and is fixed to the upper surface of the upper rail 12 so that the center thereof in the width direction overlaps the center of the upper rail 12 in the width direction. Furthermore, as described above, the attachment bracket 15 is fixed to the upper surface of the upper rail 12 by the bolt 18.

The attachment bracket 15 according to this embodiment includes a bottom wall portion 50 that has a substantially rectangular plate shape and has a width slightly larger than the width of the upper surface of the upper rail 12 (the distance in the width direction), a front link attachment portion 52 and a back link attachment portion 53 that are uprightly formed from the vehicle inner long edges, an outer upright edge 54 that is uprightly formed toward the upper side of the vehicle from the vehicle outer long edge, and the other member attachment piece group 55 that is uprightly formed toward the upper side of the vehicle from the back side of the vehicle outer long edge.

As described above, the bottom wall portion 50 is a substantially rectangular plate-shaped portion, and is attached to face the longitudinal direction of the upper surface of the upper rail 12, that is, the front to back direction of the vehicle. The bottom wall portion 50 is provided with a bolt hole (not illustrated) into which the bolt 18 is inserted. Each bolt hole is formed at each of both ends in the front to back direction of the vehicle. Here, the bolt hole may be formed as an elongated hole (loose hole) in the longitudinal direction of the upper rail 12. In this way, if the bolt hole is formed as the loose hole, in a case where the attachment bracket 15 is fixed onto the upper rail 12, the bolt 18 is inserted into the bolt hole, and is temporarily assembled by the nut. Then, the attachment bracket 15 may be moved in the longitudinal direction of the upper rail 12. Therefore, according to the above-described configuration, the fixing position of the attachment bracket 15 in the upper rail 12 may be adjusted in the longitudinal direction of the upper rail 12. Accordingly, the fixing position of the attachment bracket 15 may be easily and highly precisely adjusted.

Of course, the bolt hole may have a size in which the fixing position of the attachment bracket 15 may be adjusted. In such a size, the bolt hole may be a truly circular hole, or the bolt hole in the front to back direction may be formed by the combination thereof.

The front link attachment portion 52 is a substantially triangular plate-shaped portion that is uprightly formed toward the upper side of the vehicle from the vehicle front end at the inner long edge of the bottom wall portion 50, and the portion corresponding to the apex angle is provided with a front insertion hole 52a into which a first front rotation shaft 7a as a rotation shaft of the driving-side link mechanism L1 (or the driven-side link mechanism L2) is inserted during the attachment of the link mechanism. The front insertion hole 52a is formed as a penetration hole that is formed in the thickness direction of the attachment bracket 15. Then, when the sensor 30 is supported at the position, the support state of the sensor 30 (in particular, the state where the sensor 30 is positioned in the width direction) may be checked.

Similarly, the back link attachment portion 53 is a substantially triangular plate-shaped portion that is uprightly formed toward the upper side of the vehicle from the vehicle back end of the outer long edge of the bottom wall portion 50, and the portion corresponding to the apex angle is provided with a back insertion hole 53a into which a first back rotation shaft 7b as a rotation shaft of the driving-side link mechanism L1 (or the driven-side link mechanism L2) is inserted during the attachment of the link mechanism. The back insertion hole 53a is formed as a penetration hole that is formed in the thickness direction of the attachment bracket 15. Then, when the sensor 30 is supported at the position, the support state of the sensor 30 (in particular, the state where the sensor 30 is positioned in the width direction of the vehicle seat Z) may be checked.

The outer upright edge 54 is an upright wall that is uprightly formed from the vehicle front end to the slightly back side of the center of the longitudinal direction. Since the outer upright edge 54 is provided, the rigidity of the attachment bracket 15 is improved. As a result, the support rigidity (the rigidity of the portion supporting the sensor 30) of the driving-side link mechanism L1 (or the driven-side link mechanism L2) and the sensor 30 supported by the link mechanisms is improved, and hence the precision of the load measurement using the sensor 30 may be improved. Furthermore, the outer upright edge 54 according to this embodiment is uprightly formed from the bottom wall portion 50 in the substantially perpendicular direction, but the present invention is not limited thereto. For example, the outer upright edge may protrude to form an obtuse angle with respect to the bottom wall portion 50.

The other member attachment piece group 55 is uprightly formed toward the upper side of the vehicle from the end of the vehicle outer long edge at the back side of the vehicle. The other member attachment piece group 55 is provided with an end of a link that is used to pivot the seat back frame 1 with respect to the seating frame 2. However, since this structure is not of direct significance to this aspect, the description thereof will not be repeated.

The driving-side link L1 according to this embodiment include a driving-side front link member 71 as a front link member, a driving-side longitudinal connection link member 72, a driving-side back link member 73 as a back link member, a sector gear 74, a rotational force transmission mechanism 76, and a track regulation member 77.

The driving-side front link member 71 is a link member that is formed in a flat plate shape that is substantially curved in a U-shape. Further, the driving-side front link member 71 is provided with four shaft penetration holes.

As for the shaft penetration hole that is formed in the driving-side front link member 71, two shaft penetration holes are formed at each of both ends in the longitudinal direction. Here, two shaft penetration holes that are formed at the end located at the lower side of the vehicle in the longitudinal direction are referred to as a “driving-side front lower shaft support hole 71a” and a “driving-side front connection pipe arrangement hole 71b” in arrangement order from the lower side of the vehicle in the seat height neutral state. Further, two shaft penetration holes that are formed at the end located at the upper side of the vehicle in the longitudinal direction are referred to as a “longitudinal connection link front shaft support hole 71c” and a “front link center hole 71d” in arrangement order from the upper side of the vehicle in the seat height neutral state.

Furthermore, in this embodiment, the width at the lower side of the vehicle in the seat height neutral state (the distance extending in the front to back direction of the vehicle in the arrangement state in the vehicle) is set to be larger than the width at the upper side of the vehicle in the seat height neutral state (the distance extending in the front to back direction of the vehicle in the arrangement state in the vehicle). With such a configuration, it is possible to dispose various components at the lower side of the vehicle in the driving-side front link member 71 in the seat height neutral state without any interference with the sensor 30.

For example, in this embodiment, the driving-side front connection pipe arrangement hole 71b is disposed, and the back side of the vehicle is provided with a regulation member that contacts the upper surface of the bottom wall portion 50 of the attachment bracket 15 at the lower position as the lowest position to stop the rotation of the driving-side front link member 71. In this way, it is possible to dispose various components in the driving-side front link member 71 without any interference with the sensor 30.

The thickness of the driving-side front link member 71 (the thickness of the periphery of at least the driving-side front lower shaft support hole 71a and the front link center hole 71d) is set to be larger than the side frame 2a (the thickness of the periphery of at least the second shaft penetration hole 21b) or the front link attachment portion 52 (the thickness of the periphery of at least the front insertion hole 52a) formed in the attachment bracket 15.

With such a configuration, since the thickness of the driving-side front link member 71 may be increased, a load may be reliably transmitted to the sensor 30 when the sensor 30 is supported.

The driving-side longitudinal connection link member 72 is a link member that is formed in a flat plate shape which draws a gentle curve in a slightly and substantially circular-arc shape, and both ends thereof are respectively provided with the shaft penetration holes.

The driving-side longitudinal connection link member 72 is disposed so that the convex portion of the curve faces the lower side of the vehicle (that is, in an upward recessed state), and the shaft penetration hole that is formed at the end located at the front side of the vehicle is referred to as a “front link shaft support hole 72a” and the shaft penetration hole that is formed at the end located at the back side of the vehicle is referred to as a “back link shaft support hole 72b” in the arrangement state.

Furthermore, the upper side of the driving-side longitudinal connection link member 72 may be provided with a rib edge that is formed along the edge (that is, the recessed curved edge). With such a structure, it is desirable in that the strength of the driving-side longitudinal connection link member 72 that transmits a force applied to the front side of the vehicle toward the back side is improved.

The driving-side back link member 73 is a link member that is formed in a flat plate shape which is slightly curved in a U-shape. Further, the driving-side back link member 73 is provided with three shaft penetration holes. Here, the shaft penetration hole that is formed at the vehicle lower side end in the seat height neutral state is referred to as a “driving-side back lower shaft support hole 73a”, and the shaft penetration hole that is formed at the vehicle upper side end in the seat height neutral state is referred to as a “longitudinal connection link back shaft support hole 73b”. Further, the shaft penetration hole that is substantially formed at the center of the driving-side back link member 73 (between the driving-side back lower shaft support hole 73a and the longitudinal connection link back shaft support hole 73b) is referred to as a “back link center hole 73c”.

Furthermore, in this embodiment, the width at the lower side of the vehicle in the seat height neutral state (the distance extending in the front to back direction of the vehicle in the arrangement state in the vehicle) is set to be larger than the width at the lower side of the vehicle in the seat height neutral state (the distance extending in the front to back direction of the vehicle in the arrangement state in the vehicle). With such a configuration, it is possible to dispose various components at the lower side of the vehicle in the driving-side back link member 73 in the seat height neutral state without any interference with the sensor 30.

The thickness of the driving-side back link member 73 (the thickness of the periphery of at least the driving-side back lower shaft support hole 73a and the back link center hole 73c) is set to be larger than the side frame 2a (the thickness of the periphery of at least the third shaft penetration hole 21c) or the back link attachment portion 53 (the thickness of the periphery of at least the back insertion hole 53a) formed in the attachment bracket 15.

With such a configuration, since the thickness of the driving-side back link member 73 may be increased, a load may be reliably transmitted to the sensor 30 when the sensor 30 is supported.

The sector gear 74 is a gear that includes an engagement portion 74c which is formed in a part of the outer peripheral surface and two shaft penetration holes. The shaft penetration hole that is formed at the vehicle lower side end in the seat height neutral state is referred to as a “sector gear center hole 74a”, and the shaft penetration hole that is formed at the vehicle upper side end in the seat height neutral state is referred to as a “link connection hole 74b”.

The rotational force transmission mechanism 76 includes a rotation operation portion 76a, a rotation transmission shaft 76b, and a pinion gear 76c. The rotation operation portion 76a is a portion that receives a rotational force, and is formed as a cylindrical knob. Furthermore, the knob may be provided with a lever.

The rotation transmission shaft 76b is a shaft that protrudes from the center portion of the rotation operation portion 76a, and rotates in the rotation direction of the rotation operation portion 76a with the rotation of the rotation operation portion. The pinion gear 76c is fixed to the free end of the rotation transmission shaft 76b, and the pinion gear 76c rotates in the rotation direction of the rotation transmission shaft 76b with the rotation of the rotation transmission shaft.

Hereinafter, the attachment state of the driving-side front link member 71, the driving-side longitudinal connection link member 72, the driving-side back link member 73, the sector gear 74, and the rotational force transmission mechanism 76 will be described.

The rotation transmission shaft 76b penetrates the first shaft penetration hole 21a formed in the side frame 2a, and is attached so that the rotation operation portion 76b is disposed at the vehicle outer side of the side frame 2a and the pinion gear 76c is disposed at the vehicle inner side.

The first link center shaft 7e penetrates the second shaft penetration hole 21b formed in the side frame 2a. The side frame 2a, the sector gear 74, and the driving-side front link member 71 are rotatably journaled to the first link center shaft 7e.

That is, the side frame 2a, the sector gear 74, and the driving-side front link member 71 are stacked so that the second shaft penetration hole 21b formed in the side frame 2a, the sector gear center hole 74a formed in the sector gear 74, and the front link center hole 71d formed in the driving-side front link member 71 communicate with one another, and the first link center shaft 7e is rotatably inserted into the communication hole.

Furthermore, the communication hole into which the first link center shaft 7e is inserted is referred to as a “second front sensor arrangement hole M3”, and the sensor 30 may be disposed at the position instead of the first link center shaft 7e. The arrangement structure will be described in Embodiments 6 and 7 below.

Then, in this state, the pinion gear 76c that constitutes the rotational force transmission mechanism 76 engages with the engagement portion 74c formed in the sector gear 74.

Further, the vehicle lower side end of the driving-side front link member 71 and the front link attachment portion 52 formed in the bracket 15 are stacked so that the driving-side front lower shaft support hole 71a formed in the vehicle lower side end of the driving-side front link member 71 communicates with the front insertion hole 52a formed in the attachment bracket 15, and the first front rotation shaft 7a is inserted into the communication hole.

Furthermore, the communication hole into which the first front rotation shaft 7a is inserted is referred to as a “first front sensor arrangement hole M1”, and the sensor 30 may be disposed at the position instead of the first front rotation shaft 7a. The arrangement structure will be described in Embodiment 1 below.

Further, the sector gear 74, the vehicle upper side end of the driving-side front link member 71, and the vehicle front end of the driving-side longitudinal connection link member 72 are stacked so that each link connection hole 74b formed in the sector gear 74, the longitudinal connection link front shaft support hole 71c formed in the driving-side front link member 71, and the front link shaft support hole 72a formed in the driving-side longitudinal connection link member 72 communicate with one another, and the second front rotation shaft 7c is inserted into the communication hole.

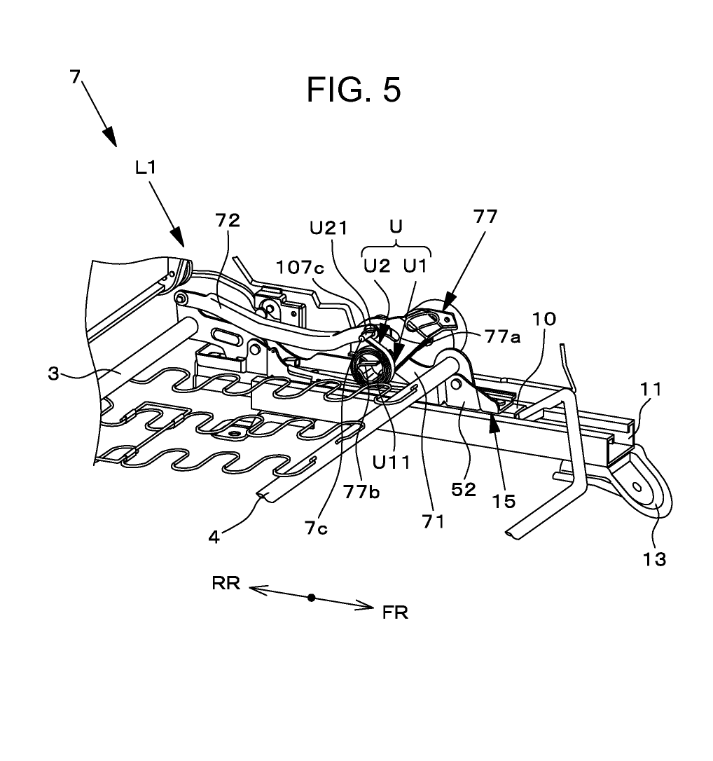

Furthermore, as illustrated in FIG. 5, the driving-side link L1 may be provided with the track regulation member 77. The track regulation member 77 is a dome-shaped member, and includes a driving-side loose hole 77a that is formed in a substantially circular-arc shape and a spring engaging piece 77b that is formed at the lower side of the driving-side loose hole 77a to protrude toward the vehicle inner side. The track regulation member 77 with such a configuration is used to regulate the track of the driving-side link L1 and to dispose the spiral spring U.

In a case where the track regulation member 77 is disposed, the sector gear 74, the vehicle upper side end of the driving-side front link member 71, the track regulation member 77, and the vehicle front end of the driving-side longitudinal connection link member 72 are stacked so that each link connection hole 74b formed in the sector gear 74, the longitudinal connection link front shaft support hole 71c formed in the driving-side front link member 71, the driving-side loose hole 77a formed in the track regulation member 77, and the front link shaft support hole 72a formed in the driving-side longitudinal connection link member 72 communicate with one another, and the second front rotation shaft 7c is inserted into the communication hole.

Thus, the second front rotation shaft 7c is adapted to slide through the driving-side loose hole 77a provided in the track regulation member 77. That is, the driving-side loose hole 77a is formed to draw the track of the second front rotation shaft 7c, and the track of the driving-side link L1 is regulated by the driving-side loose hole 77a of the track regulation member 77.

Further, in this case, the second front rotation shaft 7c is formed to protrude toward the vehicle inner side, and is formed so that the spiral spring U may be disposed. Here, the vehicle inner side end of the protruding second front rotation shaft 7c is referred to as an “upper spring latching portion 107c”.

The spiral spring U is an elastic member that includes a spiral portion U1 which turns in a spiral shape and an outer latching portion U2 that is uprightly formed from the direction opposite to the turning direction from the tangential direction of the outermost peripheral circle. The center portion of the spiral portion U1 forms an “inner spring peripheral portion U11”, and the end of the outer latching portion U2 is provided with a “hook portion U21” that is opened while being bent in the direction opposite to the turning direction. In the spiral spring U, the hook portion U22 is latched by the upper spring latching portion 107c, and the inner spring peripheral portion U11 is hung by the spring engaging piece 77b, and the spiral spring is assembled to bias the driving-side front link member 71 in a direction in which the driving-side front link member stands.

Further, the vehicle lower side end of the driving-side back link member 73 and the back link attachment portion 53 formed in the bracket 15 are stacked so that the driving-side back lower shaft support hole 73a formed in the vehicle lower side end of the driving-side back link member 73 communicates with the back insertion hole 53a formed in the attachment bracket 15, and the first back rotation shaft 7b is inserted into the communication hole.

Furthermore, the communication hole into which the first back rotation shaft 7b is inserted is referred to as a “first back sensor arrangement hole M2”, and the sensor 30 may be disposed at the position instead of the first back rotation shaft 7b. The arrangement structure will be described in, for example, Embodiment 1.

Further, the side frame 2a and the substantial center portion of the driving-side back link member 73 are stacked so that the third shaft penetration hole 21c formed in the side frame 2a communicates with the back link center hole 73c formed at the substantial center portion of the driving-side back link member 73, and one end of the back connection pipe 3 is inserted into the communication hole. The communication hole into which one end of the back connection pipe 3 is inserted is referred to as a “second back sensor arrangement hole M4”, and the sensor 30 may be disposed at the position.

Here, as for the method of disposing the sensor 30 at the second back sensor arrangement hole M4, the sensor body 32 of the sensor 30 may be built on the inner side of the back connection pipe or the sensor 30 may be inserted into the second back sensor arrangement hole M4 instead of one end of the back connection pipe 3 and the other arrangement hole (for example, the arrangement hole which is the same as the driving-side front connection pipe arrangement hole 71b formed in the driving-side front link member 71) may be formed. Further, the sensor 30 may be inserted into the second back sensor arrangement hole M4 instead of one end of the back connection pipe 3 and the back connection pipe 3 may be rotated by the other configuration.

Further, the vehicle upper side end of the driving-side back link member 73 and the vehicle back end of the driving-side longitudinal connection link member 72 may be stacked so that the longitudinal connection link back shaft support hole 73b formed in the vehicle upper side end of the driving-side back link member 73 communicates with the back link shaft support hole 72b at the vehicle back side of the driving-side longitudinal connection link member 72, and the second back rotation shaft 7d is inserted into the communication hole.

The driven-side link L2 according to this embodiment has a configuration in which the driving-side longitudinal connection link member 72, the sector gear 74, and the rotational force transmission mechanism 76 are removed from the driving-side link mechanism L1. Since the other configurations are substantially the same, the description of the common point will not be repeated.

A driven-side front link member 81 corresponds to the front link member, has a configuration substantially the same as that of the driving-side front link member 71, and pivots as in the case of the driving-side front link member 71 while being interlocked with the movement of the front connection pipe 4 following the movement of the driving-side front link member 71. Further, the same member as the track regulation member 77 may be provided, and the regulation member is used to regulate the pivot track and exhibit the return effect using the spiral spring U as described above.

A driven-side back link member 83 corresponds to the back link member and has the same configuration as that of the driving-side back link member 73. However, since the configuration corresponding to the driving-side longitudinal connection link member 72 is not needed, the configuration of the upper end does not exist. That is, since the longitudinal connection link back shaft support hole 73b does not exist, the portion provided with the hole does not exist.

Then, the driven-side back link member 83 pivots as in the case of the driving-side back link member 73 while being interlocked with the movement of the back connection pipe 3 following the movement of the driving-side back link member 73. In this way, since the driven-side link L2 is operated to follow the movement of the driving-side link L1, the pair of side frames 2a and 2a performs the same operation (the height displacement operation) in a synchronized state.

With the above-described configuration, when the rotation operation portion 76a rotates, the rotation transmission shaft 76b rotates in the same direction. Accordingly, the pinion gear 76c rotates in the same direction, and the sector gear 74 engaging with the pinion gear rotates in the opposite direction. In this way, when the sector gear 74 rotates, the driving-side front link member 71 and the driving-side longitudinal connection link member 72 connected to the sector gear 74 pivot. Then, the driving-side back link member 73 pivots with the pivoting of the driving-side longitudinal connection link member 72, and hence the height of the side frame 2a is displaced.

Then, since the driven-side link L1 moves in an interlocked manner due to the above-described series of operations as described above, the pair of side frames 2a and 2a is displaced in a synchronized state in the same way.

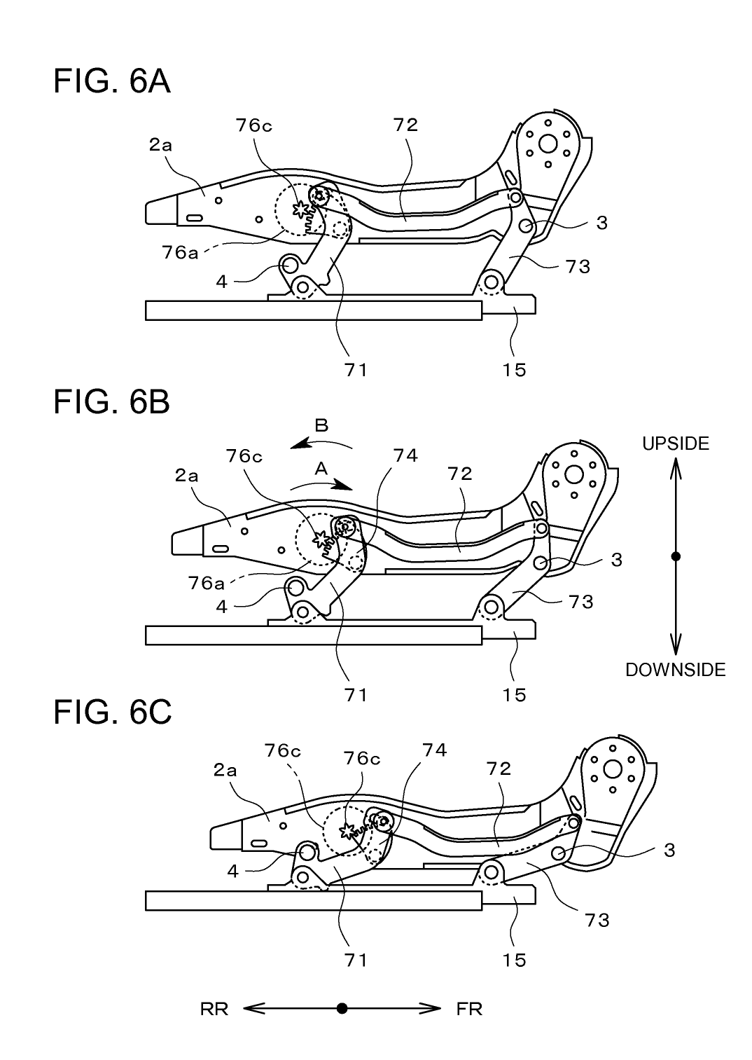

Subsequently, the movement of the height adjustment mechanism using the link mechanism L with the above-described configuration will be described with reference to FIG. 6. FIG. 6B illustrates a middle point (neutral position).

When the rotation operation portion 76a is rotated in the direction A while being located at the middle point (when a lever is moved upward in a case where the lever is provided to extend from the rotation operation portion 76a toward the front side of the vehicle), the sector gear 74 rotates in the direction B through the pinion gear 76c. In accordance with this movement, the driving-side front link member 71 rises so that the upper portion thereof may be drawn toward the front side of the vehicle (since the lower end side just rotates without any displacement). Accordingly, the driving-side longitudinal connection link member 72 may be drawn toward the front side.

Due to the above-described result, the driving-side back link member 73 rises, and the position of the driving-side longitudinal connection link member 72 ascends. Accordingly, the side frame 2a that is connected to the driving-side link L1 ascends to be displaced to the ascending position (the upper position) of FIG. 6A. Furthermore, as described above, the driven-side link mechanism L2 and the side frame 2a connected thereto are displaced to follow the displacement.

In contrast, when the rotation operation portion 76a is rotated in the direction B from the neutral position (when a lever is moved down in a case where the lever is provided to extend from the rotation operation portion 76a toward the front side of the vehicle), the sector gear 74 rotates in the direction A through the pinion gear 76c. In accordance with this movement, the position of the upper end of the driving-side front link member 71 descends so that the driving-side front link member is inclined backward (since the lower end side just rotates without any displacement), and hence the upper portion may be drawn toward the back side of the vehicle.

Then, the driving-side longitudinal connection link member 72 may be drawn toward the back side in accordance with the above-described operation. As a result, the position of the upper end of the driving-side back link member 73 descends so that the driving-side back link member is inclined backward, and the position of the upper end of the driving-side longitudinal connection link member 72 descends. Accordingly, the side frame 2a connected to the driving-side link mechanism L1 descends, and is displaced to the descending position (the lower position) of FIG. 6C. Furthermore, as described above, the driven-side link mechanism L2 and the side frame 2a connected thereto are displaced to follow the displacement.

In this way, the height of the seat is adjusted by the height adjustment mechanism 7.

### Structure of the Sensor

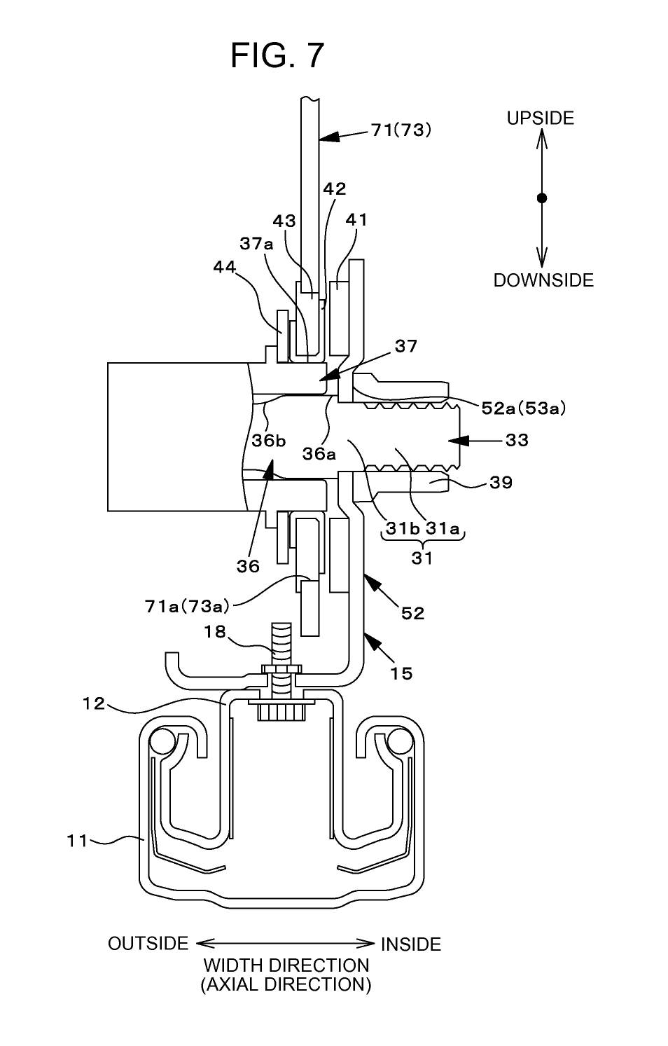

Next, the sensor 30 according to this embodiment will be described with reference to FIG. 7.

As illustrated in FIG. 7, the sensor 30 includes a shaft body 33. The shaft body 33 includes an extension shaft portion 31 and the sensor body 32. Furthermore, in this embodiment, in the metallic shaft body 33 of which one end is provided with a male screw, the extension shaft portion 31 is formed by the end provided with the male screw. The sensor body 32 includes a large diameter portion which is formed in the shaft body, an outer cylinder body into which the shaft body 33 is inserted, and a circuit board unit (not illustrated). Furthermore, the shaft body 33 provided with the extension shaft portion 31 is attached to the outer cylinder body forming the sensor body 32, and is integrated with the outer cylinder body. Furthermore, in this embodiment, the male screw that is formed in the extension shaft portion 31 of the shaft body 33 is formed in the entire outer peripheral surface.

The extension shaft portion 31 is a bolt-shaped portion that is provided to assemble the sensor 30 to the seat unit S, and extends from the lateral side of the sensor body 32. Further, the extension shaft portion 31 includes a male screw portion 31a that is formed in one end of the shaft body in the axial direction and an adjacent portion 31b that is adjacent to the male screw portion 31a in the axial direction. The diameter of the adjacent portion 31b is equal to the portion corresponding to the thread ridge of the male screw portion 31a. Furthermore, in this embodiment, a case has been described in which the extension shaft portion 31 is provided with the male screw portion 31a, but the extension shaft portion may be provided with a female screw.

The sensor body 32 is a main portion of the sensor 30, and is used to detect a load generated when the passenger sits on the vehicle seat Z and to measure the load. The sensor body 32 includes a positioning portion 35 that positions the sensor 30 and a load detection unit 37 that is deformed to detect a load. The positioning portion 35 is a step portion that is adjacent to the adjacent portion 31b at the opposite side to the male screw portion 31a in the shaft body 33 provided with the extension shaft portion 31. The step portion that forms the positioning portion 35 has an outer diameter slightly larger than that of the male screw portion 31a or the adjacent portion 31b.

The load detection unit 37 is formed by an annular portion that is located at the opening end in the substantially cylindrical outer cylinder body that surrounds the shaft body 33. The load detection unit 37 corresponds a deformation portion, and is deformed so that the load detection unit 37 is bent in the radial direction when a load is generated in the radial direction of the annular portion of the load detection unit 37 (in other words, the radial direction of the extension shaft portion 31). The sensor body 32 detects the deformation amount of the load detection unit 37 by a strain sensor (not illustrated), and measures the magnitude of the load from the deformation amount.

The circuit board unit is used to output the load measurement result as an electric signal, and is disposed at the lateral side of the sensor body 32. The circuit board unit is equipped with a connector portion (not illustrated) that is electrically connected to a receiver (not illustrated) receiving the electric signal, and includes a circuit board accommodation casing other than a circuit board. The connector portion (not illustrated) protrudes horizontally from the center position of the side surface of the circuit board accommodation casing.

In addition, the sensor body 32 includes a portion (hereinafter, an accommodation shaft portion 36) accommodated inner side the outer cylinder body in the shaft body 33 provided with the extension shaft portion 31. As illustrated in FIG. 7, the accommodation shaft portion 36 includes an equal diameter portion 36a that extends from the step portion forming the positioning portion 35 in the axial direction of the shaft body while keeping a diameter substantially equal to the adjacent portion 31b and an unequal diameter portion 36b of which the diameter decreases at the equal diameter portion 36a and increases again at the base portion. Furthermore, the outer diameter of the equal diameter portion 36a becomes slightly smaller than the inner diameter of the annular portion of the load detection unit 37.

The sensor 30 with the above-described configuration is supported so that the extension shaft portion 31 is located at the lateral side of the sensor body 32. More specifically, as illustrated in FIG. 7, the sensor 30 is assembled from the vehicle outer direction toward the vehicle inner direction so that the extension shaft portion 31 follows the horizontal direction. Furthermore, when the sensor 30 is supported at a predetermined position, the sensor body 32 including an annular portion as the load detection unit 37 is inserted into the penetration hole formed in each link member. Furthermore, the arrangement position of the annular portion will be described in detail in Embodiments 1 to 7.

In this embodiment, when the passenger sits on the vehicle seat Z, the load that is generated at that time is transmitted to the load detection unit 37 of the sensor body 32 through each link member. More specifically, each link member is located at the outer side of the annular portion in the radial direction of the annular portion (the radial direction of the extension shaft portion 31), and presses the load detection unit 37 inward in the radial direction to transmit the load to the load detection unit 37. Here, a portion that is pressed by each link member is the uppermost circumferential portion in the annular portion. Specifically, in the outer peripheral surface of the annular portion as the load detection unit 37, an area corresponding to the uppermost circumferential portion becomes a load receiving surface 37a. Here, the load receiving surface 37a corresponds to a load receiving portion.

Then, when a load is input (transmitted) to the load receiving surface 37a, a portion provided with the load receiving surface 37a in the annular portion is deformed to be strained inward in the radial direction. Accordingly, the sensor body 32 detects a load in a direction (specifically, the downward vertical direction) perpendicular to the load receiving surface 37a.

Furthermore, the equal diameter portion 36a of the accommodation shaft portion 36 having a diameter slightly smaller than the inner diameter of the annular portion is disposed at the inner side of the annular portion as the load detection unit 37 in the radial direction (see FIG. 7). Thus, when the annular portion as the load detection unit 37 is strained inward in the radial direction by the input load from the vehicle seat Z, the annular portion is bent until contacting the equal diameter portion 36a, and hence the bent amount is regulated so that the annular portion is not excessively bent. That is, an area contacting the annular portion in the equal diameter portion 36a is used to regulate the deformation amount when the annular portion is deformed.

Here, the equal diameter portion 36a is disposed at a position that meets a load center point when the load applied to the vehicle seat Z is applied to the load detection unit 37 through the link member in the axial direction of the extension shaft portion 31. Here, the load center point indicates the load concentration point of the sensor body 32 when the load detection unit 37 of the sensor body 32, that is, the annular portion, receives the load from the vehicle seat Z. The load center point of this embodiment exists in the load receiving surface 37a, and is generally located at the center position of the load receiving surface 37a in the axial direction of the extension shaft portion 31.

Since the equal diameter portion 36a exists at the above-described position, the equal diameter portion 36a receives the portion corresponding to the load center point of the load detection unit 37. As a result, it is possible to suppress the annular portion from being excessively deformed by the biased load or the like, and hence the sensor 30 may stably perform the load measurement.

Further, in this embodiment, as illustrated in FIG. 7, the length of the equal diameter portion 36a in the axial direction of the extension shaft portion 31 becomes larger than the length (the thickness) of each link member attached in the same direction. That is, the equal diameter portion 36a exists in the range in which the annular portion as the load detection unit 37 is pressed by the link member in the axial direction. Thus, the equal diameter portion 36a receives the load detection unit 37 in the entire range pressed by the link member, and hence the load measurement may be further stably performed.

### Sensor Attachment Component

Components (hereinafter, sensor attachment components 40) are provided which are used to attach the sensor 30 at a predetermined position to perform a satisfactory load measurement while being disposed in the periphery of the sensor body 32, that is, the annular portion provided with the load detection unit 37 in a state where the sensor 30 is supported at a predetermined position. Hereinafter, each of the sensor attachment components 40 will be described with reference to FIGS. 7 to 9.

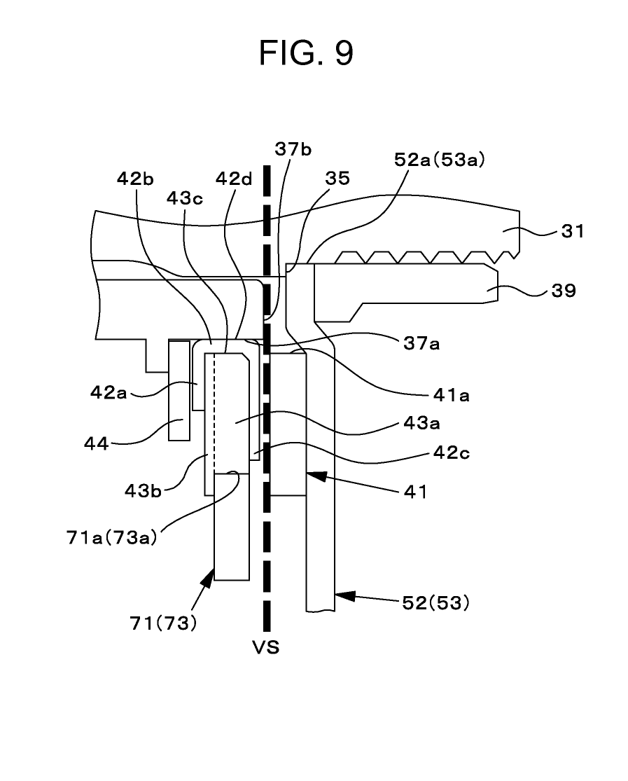

As illustrated in FIG. 9, the sensor attachment components 40 are arranged in order of a spacer 41, a sliding member 42, a bushing 43, and a washer 44 from the inner side of the width direction of the vehicle seat Z.

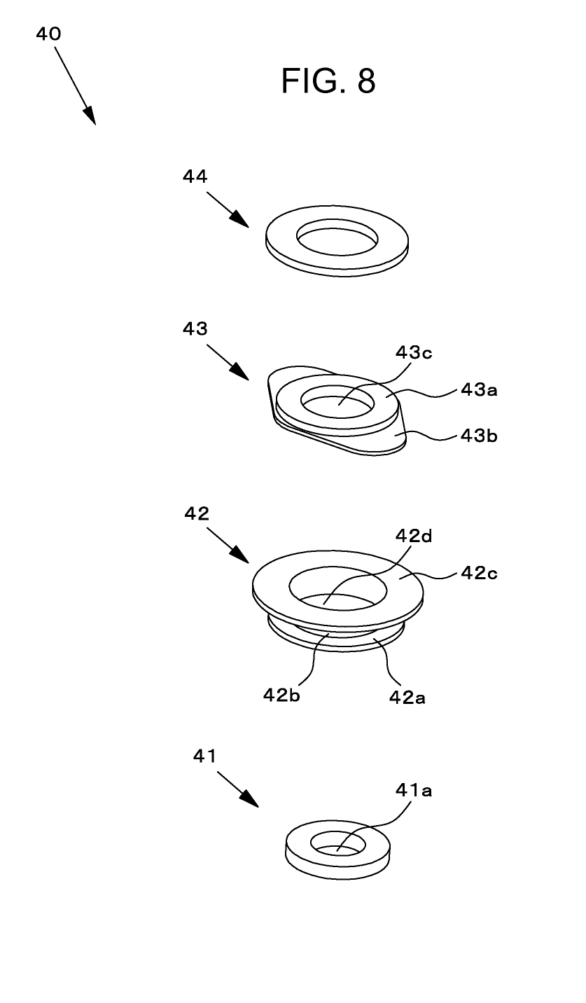

The bushing 43 is provided to transmit a load from the seat frame F provided in the vehicle seat Z to the sensor 30. The bushing 43 is a member that is made of a hot-rolled steel plate (SPHC), and has a structure in which a cylindrical portion 43a is adjacent to a substantially rhombic flange portion 43b in the thickness direction as illustrated in FIG. 8. That is, the flange portion 43b is formed to extend from one end of the cylindrical portion 43a in the axial direction outward in the radial direction. A penetration hole 43c is formed at the center position of the bushing 43 to penetrate both the cylindrical portion 43a and the flange portion 43b. The diameter of the penetration hole 43c is slightly larger than the outer diameter of the annular portion as the load detection unit 37 in the sensor body 32. The thickness of the cylindrical portion 43a is substantially equal to the thickness of the link member, and the outer diameter is substantially equal to the diameter of the penetration hole.

In the bushing 43 with the above-described shape, the sensor 30 is inserted into the penetration hole 43c, and the bushing 43 is located at the outer side of the radial direction of the annular portion as the load detection unit 37 in the sensor body 32. That is, the bushing 43 is located at a position where each link member presses the sensor body 32 of the sensor 30.

With the above-described configuration, when the annular portion is pressed to transmit the load generated when the passenger sits on the vehicle seat Z, each link member may press a larger area by the amount corresponding to the thickness of the flange portion 43b of the bushing 43. That is, the bushing 43 is a load transmission member that is used to widen the pressing area when each link member presses the annular portion.

Further, as illustrated in FIG. 8, the length (the thickness) of the bushing 43 in the axial direction of the extension shaft portion 31 becomes larger than the length of the equal diameter portion 36a in the same direction. Then, the bushing 43 is provided so that both ends of the bushing 43 in the axial direction are located at the inner side of both ends of the equal diameter portion 36a in the axial direction. With the above-described configuration, even when the pressing range is widened by the bushing 43, the equal diameter portion 36a receives the load detection unit 37 in the entire widened range. Thus, the further stable load measurement may be performed while obtaining the effect of the bushing 43.

The sliding member 42 is provided to transmit the load from the seat frame F provided in the vehicle seat Z to the sensor 30 while contacting the sensor 30. Further, the sliding member 42 is formed of a resin member having a satisfactory sliding performance so that the sliding member easily slides on the sensor 30 in the axial direction of the extension shaft portion 31 when the load is applied thereto.

More specifically, the sliding member 42 is an annular member that is formed of an ethylene resin, and is interposed between the annular portion and the bushing 43 in the radial direction of the annular portion as the load detection unit 37 (in other words, the radial direction of the extension shaft portion 31). Further, the sliding member 42 includes a cylindrical fitting cylinder portion 42b that is fitted to the penetration hole 43c of the bushing 43, a one-end-side flange portion 42a that is adjacent to one end of the fitting cylinder portion 42b, and the other-end-side flange portion 42c that is adjacent to the other end of the fitting cylinder portion 42b. In a state where the fitting cylinder portion 42b penetrates the penetration hole 43c of the bushing 43, the one-end-side flange portion 42a and the other-end-side flange portion 42c interpose the bushing 43 therebetween (see FIG. 9). Furthermore, in this embodiment, the one-end-side flange portion 42a has a diameter smaller than that of the other-end-side flange portion 42c. In this way, since the sliding member 42 includes the one-end-side flange portion 42a and the other-end-side flange portion 42c that are formed in a flange shape, the rigidity of the sliding member 42 is improved.

Further, the sliding member 42 is provided with a penetration hole 42d that penetrates the one-end-side flange portion 42a, the fitting cylinder portion 42b, and the other-end-side flange portion 42c in the thickness direction. The penetration hole 42d is slightly larger than the outer diameter of the annular portion. Then, when the sensor 30 is supported at a predetermined position, the annular portion is fitted into the penetration hole 42d in a state where a minute gap is formed between the penetration hole 42d of the sliding member 42 and the annular portion. Furthermore, in this embodiment, the sliding member 42 is attached so that the one-end-side flange portion 42a is separated from the front end of the extension shaft portion 31 in relation to the other-end-side flange portion 42c in the axial direction of the extension shaft portion 31.

When the link member presses the annular portion, the sliding member 42 is interposed between the bushing 43 and the annular portion in the radial direction of the annular portion to contact the outer peripheral surface of the annular portion, that is, the load receiving surface 37a. For this reason, the sliding member 42 may be called a load input member that finally inputs the load transmitted through the link member and the bushing 43 to the annular portion. That is, the sliding member 42 as the load input member directly presses the annular portion while contacting the annular portion 37 when the load transmitted from the link member is transmitted to the annular portion.

Then, the sliding member 42 is disposed to be separated from the other members (specifically, the spacer 41 and the washer 44) which are adjacent to each other in the thickness direction. That is, since the sliding member 42 is disposed with a gap between the sliding member and the other member in the axial direction of the extension shaft portion 31, the sliding member 42 may move in the axial direction in the event of the load from the link member. More specifically, when the annular portion as the load detection unit 37 is strained inward in the radial direction due to the load transmitted from the link member to the sensor 30, the sliding member 42 slides on the outer peripheral surface of the annular portion outward in the center axial direction of the annular portion with the deformation. That is, the sliding member 42a movable portion (a movable member) that slides on the outer peripheral surface of the annular portion to follow the deformation of the annular portion.

In this way, since the sliding member 42 slides toward the outer side, that is, toward the extension shaft portion 31, the sensor 30 may receive the load at the fixed portion. As a result, since the load is stably input from the link member to the sensor 30, the detection precision is improved.

In addition, the sliding member 42 is disposed at the outer side of the seat width direction in relation to the positioning portion 35, and is disposed at the position close to the circuit board unit in relation to the outer end of the load detection unit 37 in the seat width direction. That is, the sliding member 42 is disposed at the position close to the circuit board unit in relation to the non-fixed end (the free end) of the load detection unit 37 in the axial direction. With such a configuration, since the sliding member 42 stably contacts the load receiving surface 37a of the sensor 30, the load detection precision may be improved. Further, it is possible to suppress a biased load from being applied to the sliding member 42.

Furthermore, the contact surface of the sliding member 42 with respect to the annular portion (that is, an area facing the load receiving surface 37a in the inner peripheral surface of the penetration hole 42d) has a breadth in the axial direction of the extension shaft portion 31. Here, one end of the contact surface in the axial direction is located at one end of one end and the other end of the vehicle seat Z in the width direction along with one end of the equal diameter portion 36a in the axial direction. In contrast, the other end of the contact surface in the axial direction is located at the other end of one end and the other end of the vehicle seat Z in the width direction along with the other end of the equal diameter portion 36a in the axial direction.

Then, one end of the contact surface in the axial direction is located at the outer side in relation to one end of the equal diameter portion 36a in the axial direction (to be separated from one end of the vehicle seat Z in the width direction). Accordingly, when the link member presses the annular portion as the load detection unit 37 through the sliding member 42, the equal diameter portion 36a receives the annular portion. Further, the equal diameter portion 36a may continuously and stably receive the annular portion even when the sliding member 42 slides.

Further, the other end of the contact surface in the axial direction is located at the inner side of the other end of the equal diameter portion 36a in the axial direction (to be separated from the other end of the vehicle seat Z in the width direction). That is, in this embodiment, the contact surface is included in the range where the equal diameter portion 36a exists in the width direction. Accordingly, the load detection unit 37 may accurately receive and detect the load while being regulated by the equal diameter portion 36a.

The washer 44 is an annular member that is formed by a steel plate (specifically, grade SU S630). The washer 44 is fitted to the annular portion as the load detection unit 37 while the sensor 30 is supported at a predetermined position, and is located at the inner side of the seat width direction of the sliding member 42 with a slight gap between the washer and the sliding member 42 as illustrated in FIG. 9. That is, the washer 44 is disposed to be adjacent to the sliding member 42 at the outer side of the sliding member 42 in the axial direction of the extension shaft portion 31. Further, the washer 44 is located at the inner side of the seat width direction of the circuit board unit to be separated from the circuit board unit.

Then, the washer 44 regulates the excessive outward movement of the sliding member 42 at the arrangement position. That is, the washer 44 serves as a movement regulation member, and regulates the sliding member 42 from moving outward in relation to the arrangement position of the washer 44.

Further, in this embodiment, as illustrated in FIG. 9, the inner end of the equal diameter portion 36a is located at the outer side of the washer 44. Accordingly, the length (the length in the axial direction) of the equal diameter portion 36a that needs to be ensured to regulate the deformation amount of the annular portion as the load detection unit 37 may be the amount of the movable range of the sliding member 42, that is, the length to the arrangement position of the washer 44, thereby suppressing an increase in the size of the equal diameter portion 36a more than is necessary.

Further, the inner peripheral end of the washer 44 is located at the further inner side of the inner end surface of the circuit board unit in the radial direction of the extension shaft portion 31, and the outer peripheral end of the washer 44 is located at the further outer side of the inner end surface of the circuit board unit in the radial direction thereof. That is, in a state where the sensor 30 is supported, the washer 44 further extends to the outer side of the inner end surface of the circuit board unit in the radial direction of the extension shaft portion 31. Thus, the washer 44 that is disposed at the arrangement position is used to suppress an accident in which the sliding member 42 moves outward in the axial direction of the extension shaft portion 31 and interferes with the circuit board unit.

Further, the outer diameter of the washer 44 is formed to be larger than the outer diameter of the one-end-side flange portion 42a of the sliding member 42. That is, the washer 44 extends to the outer side of the radial direction in relation to the outer diameter of the one-end-side flange portion 42a of the sliding member 42. In this way, since the outer diameter of the washer 44 is larger than the outer diameter of the sliding member 42, even when the sliding member 42 slides in the axial direction, the movement may be reliably prohibited by the washer 44.

Furthermore, in this embodiment, a configuration has been described in which the washer 44 is provided separately from the sensor 30 (the sensor body 32), but for example, the washer may be integrally formed with the annular portion. When the washer 44 is integrally formed, the number of components may be decreased, and hence the time taken for the operation of attaching the sensor 30 may be shortened.

The spacer 41 is a cylindrical member that is formed by a hot-rolled steel plate. As illustrated in FIG. 9, in a state where the sensor 30 is supported at a predetermined position, the spacer is disposed in a gap between the attachment member (for example, the attachment bracket 15 or the side frame 2a) of the spacer 41 and the sliding member 42 and is adjacent to the sliding member 42 in the width direction with a slight gap therebetween. Further, a circular hole 41a is formed at the center portion of the spacer 41, and the diameter thereof is larger than the diameter of the step portion forming the positioning portion 35 in the sensor 30.

The spacer 41 with the above-described shape is coupled to the attachment member so that the penetration hole formed in the attachment member of the spacer 41 and the circular hole 41a of the spacer 41 coaxially overlap each other. Then, when the extension shaft portion 31 inserted for the attachment of the sensor 30, the extension shaft portion 31 is led through the circular hole 41a of the spacer 41. Further, at the time point in which the positioning portion 35 of the sensor 30 contacts the attachment portion so that the sensor 30 is positioned in the width direction, the spacer 41 is located at the outer side of the positioning portion 35 in the radial direction of the extension shaft portion 31 as illustrated in FIG. 9.

The spacer 41 that is set in this way serves as a stopper that regulates the sliding member 42 from excessively moving outward in the axial direction of the extension shaft portion 31. More specifically, the spacer 41 regulates the sliding member 42 from being separated from the annular portion when the sliding member 42 moves outward in the axial direction of the extension shaft portion 31 from the outer side of the annular portion as the load detection unit 37 in the radial direction of the extension shaft portion 31.

Furthermore, in this embodiment, the thickness of the spacer 41 is slightly large. Then, when the sensor 30 is inserted into the front insertion hole 52a until the positioning portion 35 contacts the attachment member of the spacer 41, the end located at the inner side of the spacer 41 in the thickness direction (that is, the end near the sliding member 42 in the width direction) reaches the free end of the annular portion (that is, the end near the spacer 41 in the axial direction of the extension shaft portion 31) in the axial direction of the extension shaft portion 31 as illustrated in FIG. 9. In other words, the inner end of the spacer 41 in the thickness direction and the free end of the annular portion overlap each other on the same virtual plane (indicated by the sign VS in FIG. 9) of which the axial direction of the extension shaft portion 31 is the normal direction. With such a positional relation, it is possible to suppress a biased load from being applied to the free end of the annular portion.

Furthermore, as a configuration different from the above-described configuration, the spacer 41 may be disposed to not overlap the end surface (the free end 37b) at the inner side of the seat width direction of the load detection unit 37 of the sensor 30 on the virtual plane (indicated by the sign VS in FIG. 9) in the radial direction of the sensor 30 (a direction perpendicular to the axial direction of the extension shaft portion 31) in a state where the sensor 30 is attached to the attachment bracket 15. When the spacer 41 is attached in such a configuration, it is possible to suppress the load detection error due to the interference between the spacer 41 and the load detection unit 37 when the load detection unit 37 is deformed by the load applied thereto.

Furthermore, in this embodiment, a configuration has been described in which the spacer 41 is provided separately from the sensor 30 (the sensor body 32). However, for example, the spacer may be integrated with the sensor 30. In this way, when the spacer 41 is integrated, the number of components may be decreased, and hence the time taken for the operation of supporting the sensor 30 may be shortened.

Based on the above-described configuration, the support structure for the sensor 30 will be described by separate embodiments.

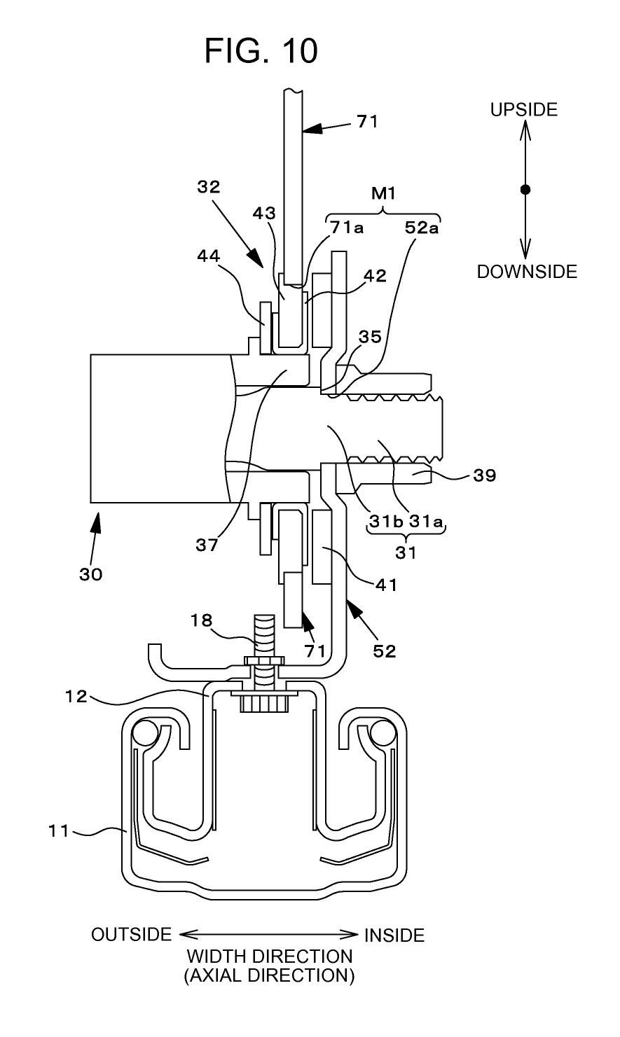

Furthermore, since the support structure for the sensor 30 is described in FIGS. 10 to 20, the structures of the rotational force transmission mechanism 76 like the sector gear 74 and the peripheral members thereof are not illustrated.

### Embodiment 1

The support structure for the sensor 30 according to Embodiment 1 will be described with reference to FIG. 10.

In Embodiment 1, two sensors 30 and 30 are respectively disposed at the “first front sensor arrangement hole M1” that causes the driving-side front lower shaft support hole 71a formed at the vehicle lower side end of the driving-side front link member 71 to communicate with the front insertion hole 52a formed in the attachment bracket 15 and the “first back sensor arrangement hole M2” that causes the driving-side back lower shaft support hole 73a formed at the vehicle lower side end of the driving-side back link member 73 to communicate with the back insertion hole 53a formed in the attachment bracket 15.

Furthermore, when the sensor 30 is disposed at the first front sensor arrangement hole M1, the size of the diameter of the first front sensor arrangement hole M1 is set to be larger than the size of the diameter of the second front sensor arrangement hole M3. Similarly, when the sensor 30 is disposed at the first back sensor arrangement hole M2, the size of the diameter of the first back sensor arrangement hole M2 is set to be larger than the size of the diameter of the second back sensor arrangement hole M4.

Thus, the diameter of the driving-side front lower shaft support hole 71a in the driving-side front link member 71 is set to be larger than the diameter of the front link center hole 71d, and the diameter of the driving-side back lower shaft support hole 73a in the driving-side back link member 73 is set to be larger than the diameter of the back link center hole 73c. When the sensor 30 is assembled in this way, the arrangement hole may be easily recognized, and the erroneous assembly may be also effectively prevented.

Since two sensors 30 and 30 are respectively disposed at the first front sensor arrangement hole M1 and the first back sensor arrangement hole M2 in the same way, an example in which the sensor 30 is disposed at the first front sensor arrangement hole M1 will be described in FIG. 10.

As illustrated in FIG. 10, the vehicle lower side end of the driving-side front link member 71 and the front link attachment portion 52 formed in the bracket 15 are stacked, and the sensor 30 is inserted into the first front sensor arrangement hole M1 as the communication hole from the vehicle outer side. The sensor 30 is inserted from the extension shaft portion 31. Specifically, the annular portion which is provided as the load detection unit 37 in the sensor body 32 is inserted into the driving-side front lower shaft support hole 71a formed in the vehicle lower side end of the driving-side front link member 71, and the extension shaft portion 31 of the sensor 30 is inserted the front insertion hole 52a formed in the attachment bracket 15 through the driving-side front lower shaft support hole 71a from the vehicle outer side. Then, the sensor 30 is inserted until the positioning portion 35 of the sensor 30 contacts the outer surface of the front insertion hole 52a formed in the attachment bracket 15. Accordingly, the sensor 30 is positioned in the width direction of the vehicle seat Z.

Then, at the time point in which the sensor 30 is positioned, the annular portion provided with the load detection unit 37 in the sensor 30 is fitted to the driving-side front lower shaft support hole 71a formed at the vehicle lower side end of the driving-side front link member 71, and the male screw portion 31a of the extension shaft portion 31 protrudes toward the outer side of the inner surface of the bracket 15, so that the adjacent portion 31b is fitted to the front insertion hole 52a of the attachment bracket 15.

Subsequently, the nut 39 is threaded into the male screw portion 31a that protrudes from the inner surface of the bracket 15 toward the vehicle outer side, so that the sensor 30 is supported at a predetermined position. In such a state, the sensor 30 takes a posture in which the axial direction of the extension shaft portion 31 follows the horizontal direction (specifically, the width direction of the vehicle seat Z). That is, in this embodiment, the sensor 30 is supported in a cantilevered state, that is, a state where one end is a fixed end with respect to the attachment brackets 15 and 16 and the other end is a free end in a posture in which the extension shaft portion 31 follows the horizontal direction.

In a case where the sensor 30 is supported in a cantilevered state, the assembling operation may be easily performed compared to the case where both ends of the sensor 30 are fixed. In a case where the sensor 30 is supported in a cantilevered state, there is a need to stabilize the position (the arrangement position) of the sensor 30 for the satisfactory measurement of the sensor 30. Accordingly, in order to stabilize the position of the sensor 30, the support member (specifically, the attachment bracket 15) that supports the sensor 30 needs to have sufficient support rigidity. In this embodiment, as described above, the rigidity of the attachment bracket 15 is improved by forming the outer upright edge 54 or the like, and hence the sensor 30 may be stably supported.

Furthermore, in this embodiment, the front insertion hole 52a is provided at a position deviated from the maximal load position where a largest load is exerted in the axial direction of the extension shaft portion 31. Here, the maximal load position is a position corresponding to the load center point. Accordingly, the sensor 30 is stably supported by the attachment bracket 15.

Then, when the passenger sits on the vehicle seat Z in a state where the sensor 30 is disposed at the above-described position, the load is applied to the load detection unit 37 of the sensor 30 through the driving-side front link member 71. Specifically, the load generated when the passenger sits on the vehicle seat Z is a load applied downward in the vertical direction. Then, when the load is generated, the driving-side front link member 71 presses the annular portion (the load detection unit 37) inserted into the driving-side front lower shaft support hole 71a at the inner peripheral surface of the driving-side front lower shaft support hole 71a. Accordingly, the load detection unit 37 is deformed to be strained inward in the radial direction of the extension shaft portion 31, and the load measurement unit measures the magnitude of the load based on the deformation amount.

As described above, when the sensor 30 is supported at a predetermined position in a posture in which the extension shaft portion 31 follows the horizontal direction, the load measurement using the sensor 30 may be performed. In other words, the support position of the sensor 30 is a position where the load measurement using the sensor 30 may be performed. Specifically, the support position indicates the position of the sensor 30 in this embodiment. Furthermore, in this embodiment, the support position is located at the first front sensor arrangement hole M1. That is, the support position is located above the lower rail 11 which is near when viewed from the sensor 30.

Further, in this embodiment, as illustrated in FIG. 7, the driving-side front link member 71 is provided at the lower side of the side frame 2a, and is disposed at the inner side of the seat width direction in relation to the center line extending in the front to back direction of the vehicle of the upper rail 12 to which the attachment bracket 15 is connected. With such a configuration, the sensor 30 may be disposed at the inner side of the seat width direction in relation to the upper rail 12. Accordingly, it is possible to suppress the sensor 30 from protruding outward in the seat width direction.

As described above so far, in Embodiment 1, the sensor 30 is provided instead of the first front rotation shaft 7a as the front rotation shaft of the attachment bracket 15 and the driving-side front link member 71 constituting the height adjustment mechanism 7. That is, since the sensor 30 is introduced instead of the originally installed component, there is no need to prepare a new installation place and an installation component for the installation of the sensor 30. In this way, in this embodiment, there is no need to modify the height adjustment mechanism 7 and the peripheral member for the installation of the sensor 30, the number of components may be decreased. For this reason, the sensor 30 may be simply installed in the vehicle seat Z that includes the height adjustment mechanism 7 at low cost. Further, since there is no need to prepare a new installation place for the installation of the sensor 30, it is possible to suppress an increase in the size of the device, that is, an increase in the size in the height direction. Accordingly, it is possible to realize a further compact device.

Further, since the sensor 30 is installed instead of the first front rotation shaft 7a as the rotation center of the driving-side front link member 71, the installation angle of the sensor 30 does not change due to the angle of the driving-side front link member 71. That is, since the first front rotation shaft 7a is not movable with respect to the attachment bracket 15 and the driving-side front link member 71 rotates about the first front rotation shaft 7a as the rotation center (in contrast, the sensor 30 is rotatable with respect to the driving-side front link member 71), the attachment angle of the sensor 30 does not change even when the driving-side front link member 71 rotates. For this reason, even when the position of the driving-side front link member 71 changes (the angle with respect to the horizontal direction changes with the adjustment of the height), the load is accurately applied to the load detection unit 37, and hence the magnitude of the load is accurately measured by the load measurement unit based on the deformation amount.

Furthermore, in this embodiment, the axes of the connection pipes 3 and 4 and the axis of the extension shaft portion 31 are disposed at different positions. With such a configuration, the interference between the sensor 30 and the connection pipes 3 and 4 may be effectively suppressed.

Subsequently, Embodiment 2 will be described as another embodiment below.

### Embodiment 2

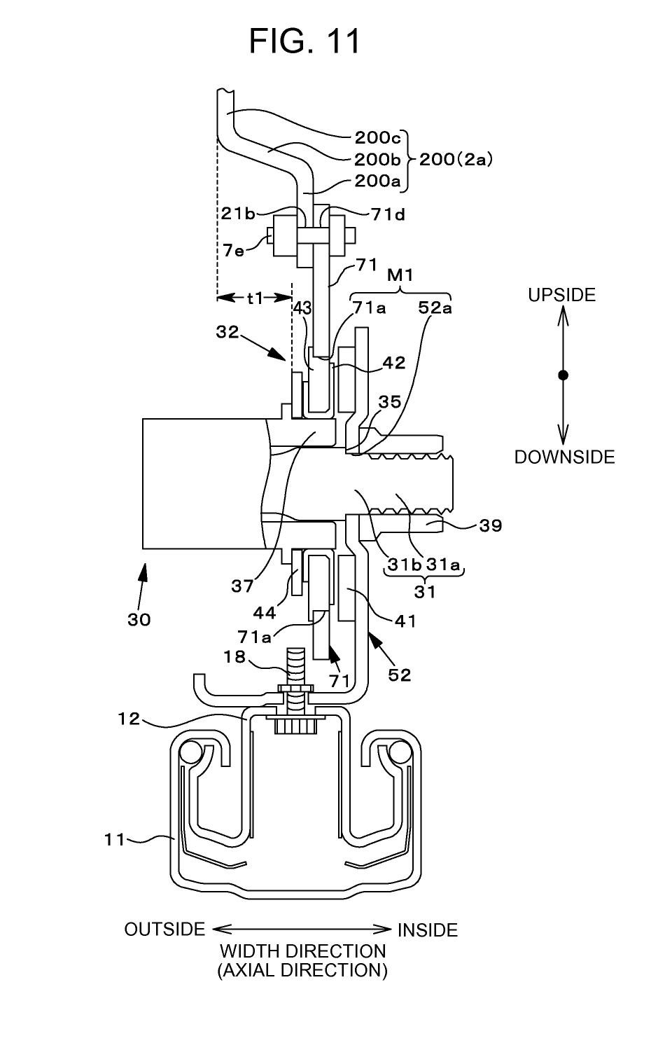

The support structure for the sensor 30 according to Embodiment 2 will be described with reference to FIG. 11.

Furthermore, since the basic configuration of the height adjustment mechanism 7, the configuration of the sensor 30, the peripheral member of the sensor 30, and the like are substantially the same as those of Embodiment 1, the description thereof will not be repeated. Accordingly, only the difference from the description above will be described. Furthermore, since the drawings become complicated, the sector gear 74 is not illustrated.

In Embodiment 2, two sensors 30 and 30 are respectively disposed at the “first front sensor arrangement hole M1” that causes the driving-side front lower shaft support hole 71a formed at the vehicle lower side end of the driving-side front link member 71 to communicate with the front insertion hole 52a formed in the attachment bracket 15 and the “first back sensor arrangement hole M2” that causes the driving-side back lower shaft support hole 73a formed at the vehicle lower side end of the driving-side back link member 73 to communicate with the back insertion hole 53a formed in the attachment bracket 15. However, the shape of the side frame 2a is modified.

Furthermore, when the sensor 30 is disposed at the first front sensor arrangement hole M1, the size of the diameter of the first front sensor arrangement hole M1 is set to be larger than the size of the diameter of the second front sensor arrangement hole M3. Similarly, when the sensor 30 is disposed at the first back sensor arrangement hole M2, the size of the diameter of the first back sensor arrangement hole M2 is set to be larger than the size of the diameter of the second back sensor arrangement hole M4.

Thus, the diameter of the driving-side front lower shaft support hole 71a in the driving-side front link member 71 is set to be larger than the diameter of the front link center hole 71d, and the diameter of the driving-side back lower shaft support hole 73a in the driving-side back link member 73 is set to be larger than the diameter of the back link center hole 73c. When the sensor 30 is assembled in this way, the arrangement hole may be easily recognized, and the erroneous assembly may be also effectively prevented.

Since two sensors 30 and 30 are respectively disposed at the first front sensor arrangement hole M1 and the first back sensor arrangement hole M2 in the same way and the driving-side front link member 71 and the driving-side back link member 73 are modified in the same way, an example in which the sensor 30 is disposed in the first front sensor arrangement hole M1 will be described in FIG. 11. Hereinafter, the side frame 2a according to Embodiment 2 will be referred to as a “second side frame 200”.

The second side frame 200 includes a lower end that is curved in a wave shape provided with a second lower end wall 200a as a lower end wall, a second center portion connection wall 200b as a center portion connection wall, and a second upper end wall 200c as an upper end wall.

The vehicle lower side end of the second lower end wall 200a is provided with the second shaft penetration hole 21b. The second lower end wall 200a is rotatably connected to the upper end of the driving-side front link member 71.

Then, the second center portion connection wall 200b extends from the upper end of the second lower end wall 200a toward the outer side of the vehicle width direction and the upper side of the vehicle while being curved to form an obtuse angle.

Further, the second upper end wall 200c extends from the upper side of the second center portion connection wall 200b toward the upper side of the vehicle to be substantially parallel to the second lower end wall 200a.

Then, the first link center shaft 7e penetrates the communication hole (corresponding to the second front sensor arrangement hole M3) between the front link center hole 71d formed in the driving-side front link member 71 and the second shaft penetration hole 21b formed in the vehicle lower side end of the second lower end wall 200a (and the sector gear center hole 74a formed in the sector gear 74).

In addition, since the link members or the support structure for the sensor 30 are the same as those of Embodiment 1, the description thereof will not be repeated.

With the above-described configuration, the sensor body 32 of the sensor 30 may be protected while being accommodated in a concave portion including the second lower end wall 200a and the second center portion connection wall 200b.

Subsequently, Embodiment 3 will be described as another embodiment below.

### Embodiment 3

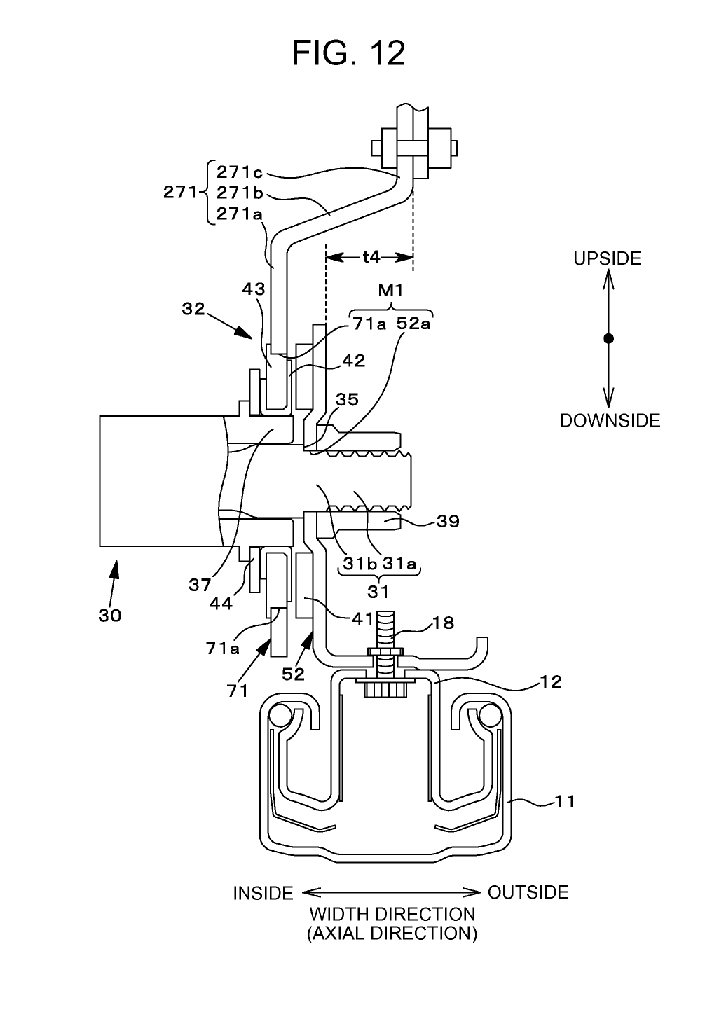

The support structure for the sensor 30 will be described with reference to FIG. 12. Furthermore, since the basic configuration of the height adjustment mechanism 7, the configuration of the sensor 30, the peripheral member of the sensor 30, and the like are substantially the same as those of Embodiment 1, the description thereof will not be repeated. Accordingly, only the difference from the description above will be described.

In Embodiment 3, two sensors 30 and 30 are respectively disposed at the “first front sensor arrangement hole M1” that causes the driving-side front lower shaft support hole 71a formed at the vehicle lower side end of the driving-side front link member 71 to communicate with the front insertion hole 52a formed in the attachment bracket 15 and the “first back sensor arrangement hole M2” that causes the driving-side back lower shaft support hole 73a formed at the vehicle lower side end of the driving-side back link member 73 to communicate with the back insertion hole 53a formed in the attachment bracket 15. However, the shapes of the driving-side front link member 71 and the driving-side back link member 73 are modified.

Furthermore, when the sensor 30 is disposed at the first front sensor arrangement hole M1, the size of the diameter of the first front sensor arrangement hole M1 is set to be larger than the size of the diameter of the second front sensor arrangement hole M3. Similarly, when the sensor 30 is disposed at the first back sensor arrangement hole M2, the size of the diameter of the first back sensor arrangement hole M2 is set to be larger than the size of the diameter of the second back sensor arrangement hole M4.

Thus, the diameter of the driving-side front lower shaft support hole 71a in the driving-side front link member 71 is set to be larger than the diameter of the front link center hole 71d, and the diameter of the driving-side back lower shaft support hole 73a in the driving-side back link member 73 is set to be larger than the diameter of the back link center hole 73c. When the sensor 30 is assembled in this way, the arrangement hole may be easily recognized, and the erroneous assembly may be also effectively prevented.

Since two sensors 30 and 30 are respectively disposed at the first front sensor arrangement hole M1 and the first back sensor arrangement hole M2 in the same way and the driving-side front link member 71 and the driving-side back link member 73 are modified in the same way, an example in which the sensor 30 is disposed at the vehicle inner side of the first front sensor arrangement hole M1 will be described in FIG. 12. Hereinafter, the driving-side front link member 71 according to Embodiment 3 will be referred to as a second driving-side front link member 271.

The second driving-side front link member 271 is a plate-shaped link member that is curved in a wave shape and includes a second lower end piece 271a as a lower end piece, a second center portion connection piece 271b as a center portion connection piece, and a second upper end piece 271c as an upper end piece.

The vehicle lower side end of the second lower end piece 271a is provided with a driving-side front lower shaft support hole 71a and a driving-side front connection pipe arrangement hole 71b in arrangement order from the lower side of the vehicle in the seat height neutral state (where these are the same as the driving-side front link member 71). Then, the second lower end piece 271a is rotatably connected to the attachment bracket 15 and extends toward the upper side of the vehicle. The second center portion connection piece 271b extends from the upper end of the second driving-side front link member 271 toward the outer side of the vehicle width direction and the upper side of the vehicle while being curved to form an obtuse angle.

Further, the upper side of the second center portion connection piece 271b is provided with the second upper end piece 271c that extends toward the upper side of the vehicle to be substantially parallel to the second lower end piece 271a, and the longitudinal connection link front shaft support hole 71c and the front link center hole 71d are formed in arrangement order from the upper side of the vehicle in the seat height neutral state (where these are the same as the driving-side front link member 71).

In addition, since the link members or the support structure for the sensor 30 are the same as those of Embodiment 1, the description thereof will not be repeated.

With the above-described configuration, it is possible to suppress the fastening portion of the sensor 30, that is, the portion protruding from the attachment bracket 15 and fastened by the nut 39 from protruding outward in the seat width direction. Further, it is possible to protect the fastening portion while the fastening portion is accommodated in a concave portion including the second lower end piece 271a and the second center portion connection piece 271b. Further, the protection range may be changed by adjusting the distance (e.g., t4: see FIG. 12) between the second lower end piece 271a and the second upper end piece 271c. That is, in a case where the space is allowable, when the distance (t4: see FIG. 12) between the second lower end piece 271a and the second upper end piece 271c is set to be larger than the distance between the outer end surface of the nut 39 and the outer surface of the front link attachment portion 52, the fastening portion may be further reliably protected.

Subsequently, Embodiment 4 will be described as another embodiment below.

### Embodiment 4

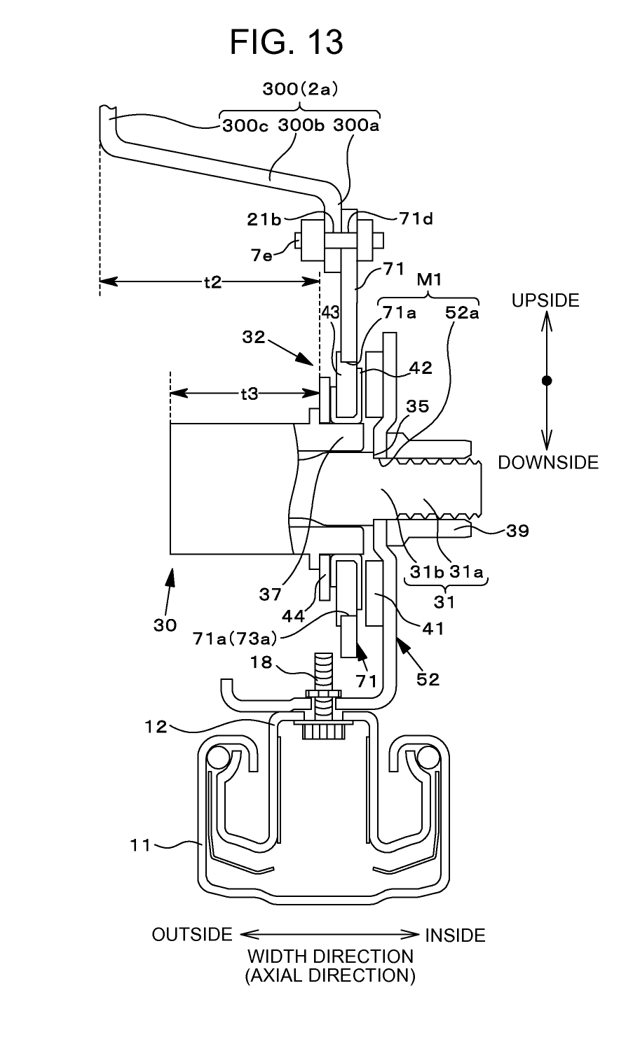

The support structure for the sensor 30 according to Embodiment 4 will be described with reference to FIG. 13.

Furthermore, since the basic configuration of the height adjustment mechanism 7, the configuration of the sensor 30, the peripheral member of the sensor 30, and the like are substantially the same as those of Embodiment 1, the description thereof will not be repeated. Accordingly, only the difference from the description above will be described. Further, since the drawings become complicated, the sector gear 74 is not illustrated.

In Embodiment 4, two sensors 30 and 30 are respectively disposed at the “first front sensor arrangement hole M1” that causes the driving-side front lower shaft support hole 71a formed at the vehicle lower side end of the driving-side front link member 71 to communicate with the front insertion hole 52a formed in the attachment bracket 15 and the “first back sensor arrangement hole M2” that causes the driving-side back lower shaft support hole 73a formed at the vehicle lower side end of the driving-side back link member 73 to communicate with the back insertion hole 53a formed in the attachment bracket 15. However, the shape of the side frame 2a is modified.

Furthermore, when the sensor 30 is disposed at the first front sensor arrangement hole M1, the size of the diameter of the first front sensor arrangement hole M1 is set to be larger than the size of the diameter of the second front sensor arrangement hole M3. Similarly, when the sensor 30 is disposed at the first back sensor arrangement hole M2, the size of the diameter of the first back sensor arrangement hole M2 is set to be larger than the size of the diameter of the second back sensor arrangement hole M4.

Thus, the diameter of the driving-side front lower shaft support hole 71a in the driving-side front link member 71 is set to be larger than the diameter of the front link center hole 71d, and the diameter of the driving-side back lower shaft support hole 73a in the driving-side back link member 73 is set to be larger than the diameter of the back link center hole 73c. When the sensor 30 is assembled in this way, the arrangement hole may be easily recognized, and the erroneous assembly may be also effectively prevented.

Since two sensors 30 and 30 are respectively disposed at the first front sensor arrangement hole M1 and the first back sensor arrangement hole M2 in the same way and the driving-side front link member 71 and the driving-side back link member 73 are modified in the same way, an example in which the sensor 30 is disposed at the first front sensor arrangement hole M1 will be described in FIG. 13. Hereinafter, the side frame 2a according to Embodiment 4 will be referred to as a “third side frame 300”.

The third side frame 300 includes a lower end that is curved in a wave shape and includes a third lower end wall 300a as a lower end wall, a third center portion connection wall 300b as a center portion connection wall, and a third upper end wall 300c as an upper end wall. The third lower end wall 300a includes the second shaft penetration hole 21b that is formed at the vehicle lower side end, and is rotatably connected to the upper end of the driving-side front link member 71. Further, the third center portion connection wall 300b extends from the upper end of the third lower end wall 300a toward the upper side and the outer side of the vehicle while being curved to form an obtuse angle.

Then, the third upper end wall 300c extends from the upper side of the third center portion connection wall 300b toward the upper side of the vehicle to be substantially parallel to the third lower end wall 300a.

Further, the first link center shaft 7e penetrates the communication hole (corresponding to the second front sensor arrangement hole M3) among the front link center hole 71d formed in the driving-side front link member 71, the second shaft penetration hole 21b formed in the vehicle lower side end of the third lower end wall 300a, and the sector gear center hole 74a formed in the sector gear 74.

In addition, since the link members and the support structure for the sensor 30 are the same as those described above, the description thereof will not be repeated. With such a configuration, the sensor body 32 of the sensor 30 may be protected while being accommodated in a concave portion including the third lower end wall 300a and the third center portion connection wall 300b.

Further, in this embodiment, the distance (e.g., t2: see FIG. 13) in the vehicle width direction between the third lower end wall 300a and the third upper end piece 300c is set to be larger than the distance (e.g., t1: see FIG. 11) between the second lower end wall 200a and the second upper end wall 200c of Embodiment 3.

In addition, the distance (t2: see FIG. 13) in the vehicle width direction between the third lower end piece 300a and the third upper end piece 300c is set to be larger than the distance (e.g., t3: see FIG. 13) between the vehicle inner surface of the third lower end piece 300a and the vehicle outer side end of the sensor 30. With such a configuration, the vehicle outer portion (the portion of the sensor body 32) of the sensor 30 is included in the concave portion between the third lower end piece 300a and the third upper end piece 300c, that is, the bent hollow range, and hence the sensor 30 may be further reliably protected.

Subsequently, Embodiment 5 will be described as another embodiment below.

### Embodiment 5

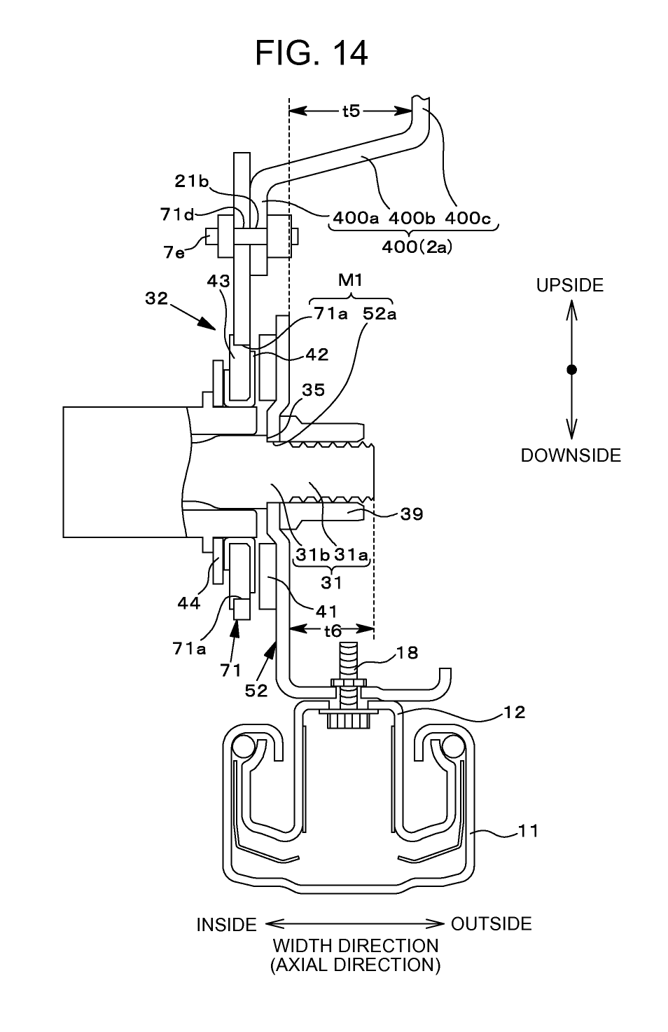

The support structure for the sensor 30 according to Embodiment 5 will be described with reference to FIG. 14.

Furthermore, since the basic configuration of the height adjustment mechanism 7, the configuration of the sensor 30, the peripheral member of the sensor 30, and the like are substantially the same as those of Embodiment 1, the description thereof will not be repeated. Accordingly, only the difference from the description above will be described. Furthermore, since the drawings become complicated, the sector gear 74 is not illustrated.

In Embodiment 5, two sensors 30 and 30 are respectively disposed at the “first front sensor arrangement hole M1” that causes the driving-side front lower shaft support hole 71a formed at the vehicle lower side end of the driving-side front link member 71 to communicate with the front insertion hole 52a formed in the attachment bracket 15 and the “first back sensor arrangement hole M2” that causes the driving-side back lower shaft support hole 73a formed at the vehicle lower side end of the driving-side back link member 73 to communicate with the back insertion hole 53a formed in the attachment bracket 15. However, the shape of the side frame 2a is modified.

Furthermore, when the sensor 30 is disposed at the first front sensor arrangement hole M1, the size of the diameter of the first front sensor arrangement hole M1 is set to be larger than the size of the diameter of the second front sensor arrangement hole M3. Similarly, when the sensor 30 is disposed at the first back sensor arrangement hole M2, the size of the diameter of the first back sensor arrangement hole M2 is set to be larger than the size of the diameter of the second back sensor arrangement hole M4.

Thus, the diameter of the driving-side front lower shaft support hole 71a in the driving-side front link member 71 is set to be larger than the diameter of the front link center hole 71d, and the diameter of the driving-side back lower shaft support hole 73a in the driving-side back link member 73 is set to be larger than the diameter of the back link center hole 73c. When the sensor 30 is assembled in this way, the arrangement hole may be easily recognized, and the erroneous assembly may be also effectively prevented.

Since two sensors 30 and 30 are respectively disposed at the first front sensor arrangement hole M1 and the first back sensor arrangement hole M2 in the same way and the driving-side front link member 71 and the driving-side back link member 73 are modified in the same way, an example in which the sensor 30 is disposed in the first front sensor arrangement hole M1 will be described in FIG. 14. Hereinafter, the side frame 2a according to Embodiment 5 will be referred to as a “fourth side frame 400”.

The fourth side frame 400 includes a lower end that is curved in a wave shape and includes a fourth lower end wall 400a as a lower end wall, a fourth center portion connection wall 400b as a center portion connection wall, and a fourth upper end wall 400c as an upper end wall. The vehicle lower side end of the fourth lower end wall 400a is provided with the second shaft penetration hole 21b. Then, the fourth lower end wall 400a is rotatably connected to the upper end of the driving-side front link member 71. Further, the fourth center portion connection wall 400b extends from the upper end of the fourth lower end wall 400a toward the upper side and the outer side of the vehicle while being curved to form an obtuse angle.

The upper side of the fourth center portion connection wall 400b is provided with the fourth upper end wall 400c that extends toward the upper side of the vehicle to be substantially parallel to the fourth lower end wall 400a. Then, the first link center shaft 7e penetrates the communication hole (corresponding to the second front sensor arrangement hole M3) among the front link center hole 71d formed in the driving-side front link member 71, the second shaft penetration hole 21b formed in the vehicle lower side end of the fourth lower end wall 400a, and the sector gear center hole 74a formed in the sector gear 74.

In addition, the configurations and the structures of the link members are the same as those of the above-described embodiments. In this embodiment, the sensor 30 is inserted from the vehicle inner side. That is, the sensor body 32 is disposed at the vehicle inner side, and the extension shaft portion 31 protrudes toward the vehicle outer side.

Furthermore, since the support structure for the sensor 30 is the same as that of the above-described embodiments, the description thereof will not be repeated.

With the above-described configuration, it is possible to suppress the fastening portion of the sensor 30, that is, the portion protruding from the attachment bracket 15 and fastened by the nut 39 from protruding toward the vehicle outer side. Further, it is possible to protect the fastening portion while the fastening portion is accommodated in a concave portion including the fourth lower end wall 400a and the fourth center portion connection wall 400b. Further, at this time, when the distance (e.g., t5: see FIG. 14) between the outer surface of the front link attachment portion 52 and the fourth upper end wall 400c is set to be larger than the distance (e.g., t6: see FIG. 14) between the outer surface of the front link attachment portion 52 and the outer end surface of the nut 39, it is possible to reliably suppress the fastening portion from protruding toward the vehicle outer side and to further reliably protect the fastening portion.

Subsequently, Embodiment 6 will be described as another embodiment below.

### Embodiment 6

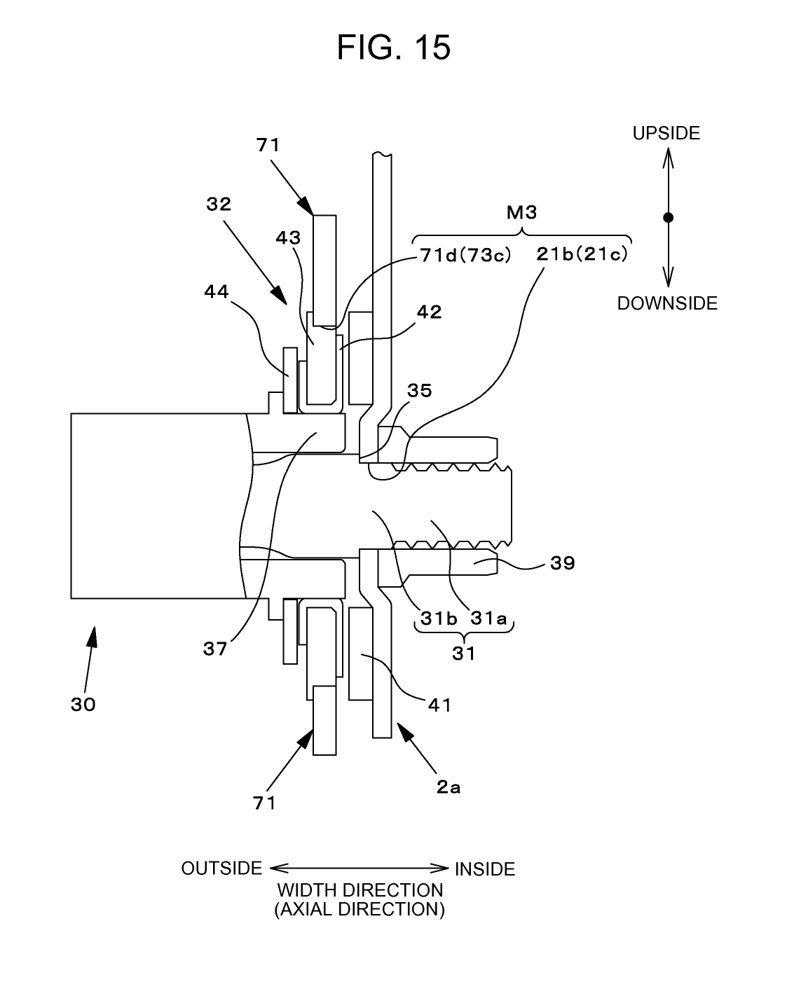

The support structure for the sensor 30 according to Embodiment 6 will be described with reference to FIG. 15.

Furthermore, since the basic configuration of the height adjustment mechanism 7, the configuration of the sensor 30, the peripheral member of the sensor 30, and the like are substantially the same as those of Embodiment 1, the description thereof will not be repeated. Accordingly, only the difference from the description above will be described. Further, the sector gear 74 is disposed at the vehicle outer side of the driving-side front link member 71, but is not illustrated in the drawings since the drawings become complicated.

In Embodiment 6, two sensors 30 and 30 are respectively disposed at the “second front sensor arrangement hole M3” as the communication hole among the second shaft penetration hole 21b formed in the side frame 2a, the sector gear center hole 74a formed in the sector gear 74, and the front link center hole 71d formed in the driving-side front link member 71 and the “second back sensor arrangement hole M4” as the communication hole between the third shaft penetration hole 21c formed in the side frame 2a and the back link center hole 73c formed at the substantial center portion of the driving-side back link member 73.

Furthermore, when the sensor 30 is disposed at the second front sensor arrangement hole M3, the size of the diameter of the second front sensor arrangement hole M3 is set to be larger than the size of the diameter of the first front sensor arrangement hole M1. Similarly, when the sensor 30 is disposed at the second back sensor arrangement hole M4, the size of the diameter of the second back sensor arrangement hole M4 is set to be larger than the size of the diameter of the first back sensor arrangement hole M2.

Thus, the diameter of the front link center hole 71d in the driving-side front link member 71 is set to be larger than the diameter of the driving-side front lower shaft support hole 71a, and the diameter of the back link center hole 73c in the driving-side back link member 73 is set to be larger than the diameter of the driving-side back lower shaft support hole 73a. With such a configuration, when the sensor 30 is assembled in this way, the arrangement hole may be easily recognized, and the erroneous assembly may be also effectively prevented

Since two sensors 30 and 30 are disposed at the second front sensor arrangement hole M3 and the second back sensor arrangement hole M4 in the same way, only an example in which the sensor is disposed at the second front sensor arrangement hole M3 will be described. Furthermore, as for the method of disposing the sensor 30 at the second front sensor arrangement hole M3, for example, a method may be employed in which the sensor 30 is inserted into the second back sensor arrangement hole M4 instead of one end of the back connection pipe 3, the other arrangement hole (for example, the arrangement hole that is the same as the driving-side front connection pipe arrangement hole 71b formed in the driving-side front link member 71) is formed, and the end of the back connection pipe 3 is rotatably connected thereto.

In addition, the sensor 30 may be inserted into the second back sensor arrangement hole M4 instead of one end of the back connection pipe 3 and the back connection pipe 3 may be rotated by the other configuration.

Further, since the same configuration as that of the driving-side longitudinal connection link member 72 constituting the driving-side link mechanism L1 is added, the back connection pipe 3 may be formed to be disconnected from the link mechanism L.

As described above, the side frame 2a, the sector gear 74, and the driving-side front link member 71 are stacked, and the sensor 30 is inserted into the second front sensor arrangement hole M3 as the communication hole from the vehicle outer side instead of the first link center shaft 7e.

That is, the sensor 30 is inserted from the extension shaft portion 31 into the second front sensor arrangement hole M3. Specifically, the sensor body 32 (more specifically, the annular portion provided with the load detection unit 37) of the sensor 30 is inserted into the front link center hole 71d formed in the driving-side front link member 71, and the extension shaft portion 31 of the sensor 30 is inserted into the second shaft penetration hole 21b formed in the side frame 2a through the front link center hole 71d. Then, the sensor 30 is inserted until the positioning portion 35 of the sensor 30 contacts the outer surface of the second shaft penetration hole 21b formed in the side frame 2a. Accordingly, the sensor 30 is positioned in the width direction of the vehicle seat Z.

Then, at the time point in which the sensor 30 is positioned, the annular portion provided with the load detection unit 37 in the sensor 30 is fitted to the front link center hole 71d formed in the driving-side front link member 71, the male screw portion 31a of the extension shaft portion 31 further protrudes toward the inner side of the inner surface of the side frame 2a, and the adjacent portion 31b is fitted to the second shaft penetration hole 21b formed in the side frame 2a.

Subsequently, the nut 39 is threaded into the male screw portion 31a that protrudes from the inner surface of the side frame 2a toward the vehicle inner side so that the sensor 30 is attached to a predetermined attachment position. In such a state, the sensor 30 takes a posture in which the axial direction of the extension shaft portion 31 follows the horizontal direction (specifically, the width direction of the vehicle seat Z). That is, in this embodiment, the sensor 30 is supported in a cantilevered state (a state where one side is a fixed end fixed to the side frame 2a and the other side is a non-fixed free end) in a posture in which the extension shaft portion 31 follows the horizontal direction.

In a case where the sensor 30 is supported in a cantilevered state, the attachment operation is easily performed compared to the case where the sensor is supported while both ends are fixed (in a state where both ends of the sensor 30 are supported). In a case where the sensor 30 is supported in a cantilevered state, there is a need to stabilize the position (the arrangement position) of the sensor 30 for the precise load measurement of the sensor 30. Accordingly, in order to stabilize the position of the sensor 30, the support member supporting the sensor 30 needs to have sufficient support rigidity. In this embodiment, since the support rigidity of the support member is ensured by employing the support member supporting the sensor 30 as the side frame 2a, the sensor 30 may be stably supported.

Furthermore, in this embodiment, the second shaft penetration hole 21b is provided at a position deviated from the maximal load position where the largest load is applied in the axial direction of the extension shaft portion 31. Here, the maximal load position is a position that corresponds to the above-described load center point. Accordingly, the sensor 30 is stably supported by the side frame 2a and the driving-side front link member 71.

Furthermore, the load measurement using the sensor 30 supported by the side frame 2a and the driving-side front link member 71 is performed in the same way as that of Embodiment 7, and hence the load measurement will be described in detail in Embodiment 7.

Subsequently, Embodiment 7 will be described as another embodiment below.

### Embodiment 7

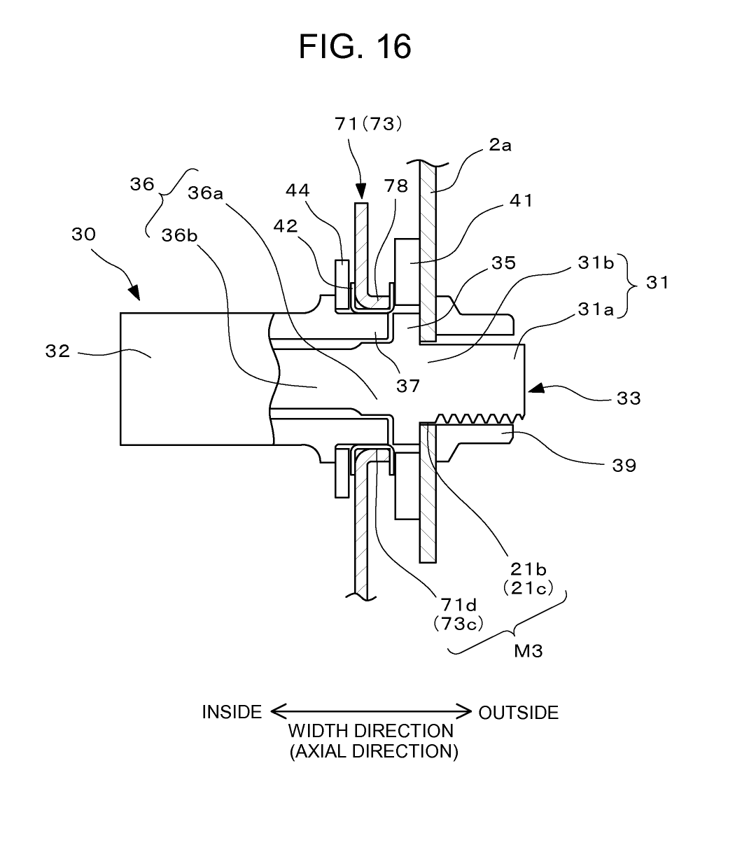

The support structure for the sensor 30 according to Embodiment 7 will be described with reference to FIGS. 16 to 20.

In Embodiment 7, as in Embodiment 6, the sensor 30 is supported by the side frame 2a, the driving-side front link member 71, and the driving-side back link member 73. Then, the support structure for the sensor 30 of Embodiment 7 is substantially similar to that of Embodiment 6 along with the height adjustment mechanism 7, the sensor 30, and the peripheral members. Hereinafter, only the difference from Embodiment 6 will be described.

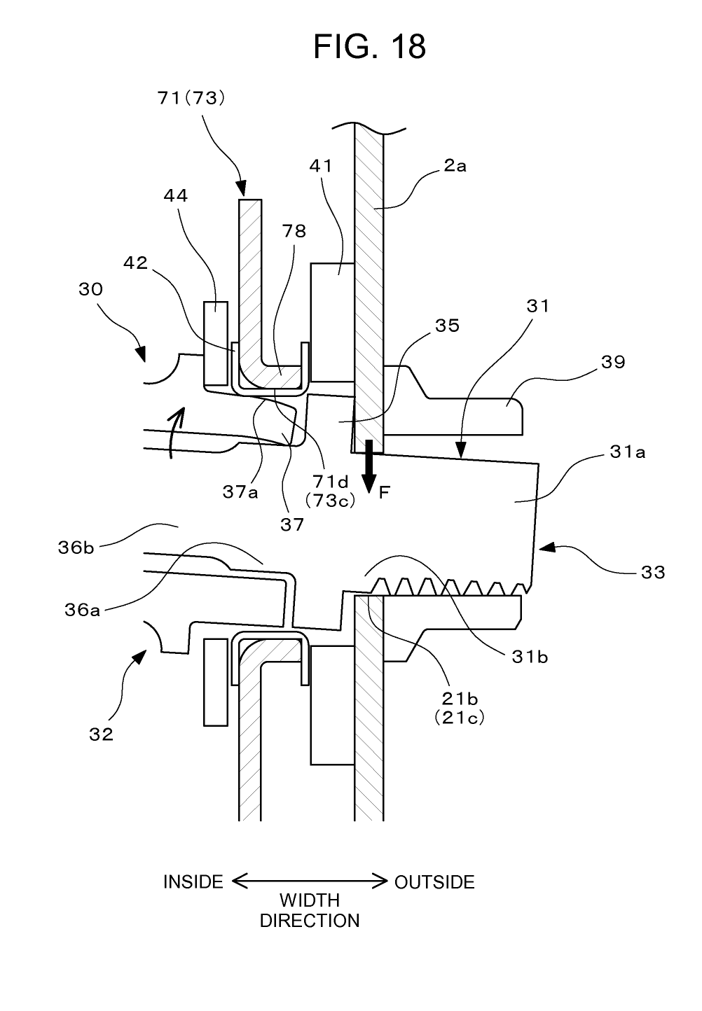

Furthermore, even in Embodiment 7, the sector gear 74 is disposed at the vehicle outer side of the driving-side front link member 71, but is not illustrated in the drawings since the drawings become complicated. Further, FIG. 18 slightly exaggerates the inclination of the load measurement sensor and the like in order to easily describe the state of the load measurement sensor in the event of a load.

In Embodiment 7, the sensor 30 is disposed at the “second front sensor arrangement hole M3” as the communication hole among the second shaft penetration hole 21b formed in the side frame 2a, the sector gear center hole 74a formed in the sector gear 74, and the front link center hole 71d formed in the driving-side front link member 71. Further, the sensor 30 is also disposed at the “second back sensor arrangement hole M4” as the communication hole between the third shaft penetration hole 21c formed in the side frame 2a and the back link center hole 73c formed at the substantial center portion of the driving-side back link member 73.

Here, since the sensors 30 are respectively disposed at the second front sensor arrangement hole M3 and the second back sensor arrangement hole M4 in substantially the same way, the method of disposing the sensor 30 at the second front sensor arrangement hole M3 will be described below.

In Embodiment 7, in a state where the sensor 30 is supported at a predetermined position, the free-end-side end of the annular portion forming the load detection unit 37 in the sensor body 32 is inserted into the front link center hole 71d formed in the driving-side front link member 71. Then, when a load is generated by the passenger sitting on the vehicle seat Z, the upper portion of the outer peripheral surface of the free-end-side end of the annular portion is pressed against the driving-side front link member 71. Accordingly, as illustrated in FIG. 18, the annular portion is deformed to be strained inward in the radial direction. That is, even in Embodiment 7, the upper portion of the outer peripheral surface of the annular portion as the load detection unit 37 corresponds to the load receiving surface 37a as the load receiving portion.

More specifically, when the passenger sits on the vehicle seat Z, the side frame 2a presses the upper end of the adjacent portion 31b of the extension shaft portion 31 downward at the inner peripheral surface of the second shaft penetration hole 21b due to the load (indicated by the arrow of the sign F in FIG. 18) generated at that time. The pressing force corresponds to the load generated when the passenger sits on the vehicle seat Z. For this reason, a portion provided with the second shaft penetration hole 21b in the side frame 2a corresponds to a load input portion, and inputs a load to the sensor 30 while contacting a portion different from the load receiving surface 37a in the sensor 30.

When a pressing force, that is, a load is input from the side frame 2a, the sensor 30 rotates about a predetermined position as illustrated in FIG. 18 due to the load input from the side frame 2a. In accordance with such a rotation, the annular portion provided with the load receiving surface 37a is pressed against the driving-side front link member 71, that is, the inner peripheral surface of the front link center hole 71d through the sliding member 42. For this reason, a portion provided with the front link center hole 71d in the driving-side front link member 71 forms the sensor body receiving portion against which the sensor body 32 is pressed with the rotation of the sensor 30. In other words, the sensor body receiving portion is disposed at the front link center hole 71d of the driving-side front link member 71. Similarly, the sensor body receiving portion is also disposed at the back link center hole 73c of the driving-side back link member 73.

As described above, in Embodiments 7 and 6, in a state where the sensor 30 is supported at a predetermined position, the load input portion and the sensor body receiving portion are separated from each other in the axial direction of the extension shaft portion 31. With such a configuration, the sensor 30 rotates by the load input from the load input portion, and hence the free-end-side end of the annular portion of the sensor body 32 is pressed against the sensor body receiving portion. As a result, the free-end-side end of the annular portion is deformed to be strained inward in the radial direction. More specifically, the load receiving surface 37a formed at the upper portion of the outer peripheral surface of the annular portion is pressed against the driving-side front link member 71. Accordingly, as illustrated in FIG. 18, the free-end-side end of the annular portion is strained to be inclined inward in the radial direction by the reaction force.

As described above, in Embodiments 7 and 6, when the passenger sits on the vehicle seat Z, the load is first input from the side frame 2a to the extension shaft portion 31 of the sensor 30, and the sensor 30 is rotated by the input load. In accordance with the rotation, the upper portion of the outer peripheral surface of the annular portion as the load detection unit 37 is pressed against the driving-side front link member 71. Finally, the free-end-side end of the annular portion is deformed to be strained inward in the radial direction. By the above-described method, the load is appropriately transmitted to the annular portion through the side frame 2a and the driving-side front link member 71. At this time, even when the input load is minute, the minute load is appropriately transmitted to the annular portion by the principle of the lever.

Furthermore, the equal diameter portion 36a of the accommodation shaft portion 36 is disposed at the inner side of the annular portion in the radial direction. At the time point in which the strain amount, in which the free-end-side end of the annular portion is strained inward in the radial direction, reaches a predetermined amount, the equal diameter portion 36a contacts the annular portion. Accordingly, it is possible to regulate the excessive strain deformation of the annular portion. Further, the equal diameter portion 36a includes an extra area that is located at both sides of the area contacting the annular portion, and the extra area serves as a foreign matter entry suppressing portion that suppresses the intrusion of the foreign matter between the annular portion and the accommodation shaft portion 36. In this way, when a single member has a function of regulating the excessive deformation of the annular portion and a function of suppressing the intrusion of the foreign matter between the annular portion and the accommodation shaft portion 36, the number of components is decreased compared to the configuration in which these functions are provided in different components.

Further, the side frame 2a and the sensor body 32 of the sensor 30 are located at the opposite side when viewed from the driving-side front link member 71. With such a positional relation, since the side frame 2a including the load input portion is separated from the sensor body 32, even when an excessive load is input from the load input portion, the sensor body 32 may be protected from the excessive load.

Next, the configuration of the support structure for the sensor 30 will be described. As described above, the support structure according to Embodiment 7 is substantially similar to the support structure according to Embodiment 6. In Embodiment 7, as illustrated in FIG. 16, the bushing 43 is not disposed at the front link center hole 71d of the driving-side front link member 71. Further, in this embodiment, the positioning portion 35 is formed in a flange shape, and the outer diameter of the positioning portion 35 is noticeably larger than the outer diameter of the equal diameter portion 36a of the accommodation shaft portion 36.

In addition, burring is performed on the outer edge of the front link center hole 71d of the driving-side front link member 71, and the outer edge is bent in an annular shape to form the annular portion 78. The annular portion 78 is a portion in which the front link center hole 71d is formed at the inner side of the driving-side front link 71 and which slightly protrudes outward in the width direction, that is, toward the near side frame 2a. Since the annular portion 78 is formed, the length of the front link center hole 71d in the width direction is longer than the annular portion 78. As a result, the annular portion is easily pressed against the inner peripheral surface of the front link center hole 71d, and hence the load is easily transmitted to the annular portion.

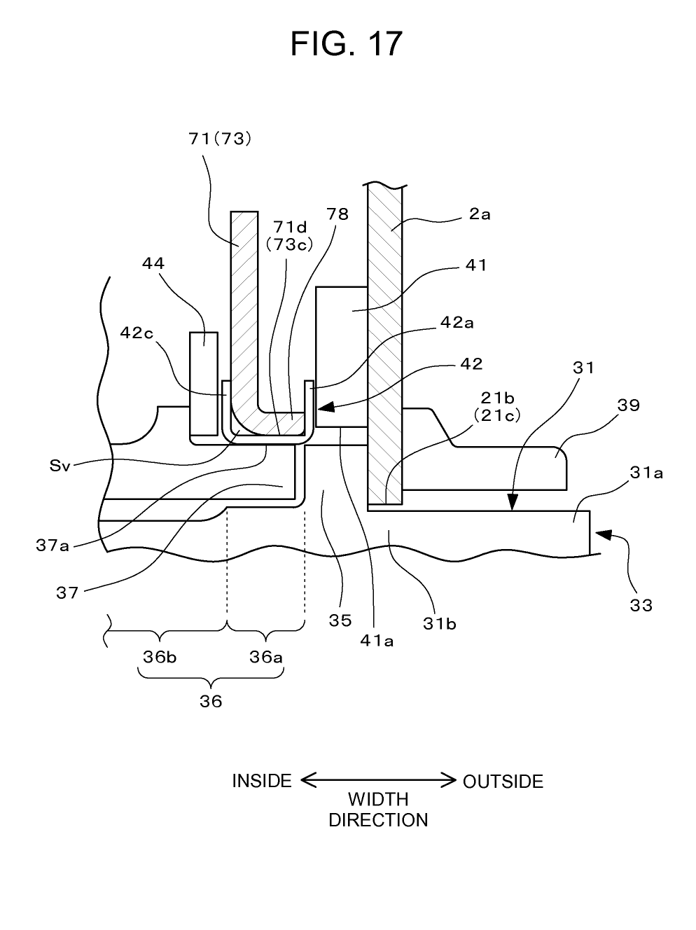

Furthermore, in the driving-side front link 71, a portion that is bent to form the annular portion 78 is bent in an R-shape as illustrated in FIG. 17. That is, in the driving-side front link 71, the opening edge of the front link center hole 71d located at the opposite side to the annular portion 78 is rounded by chamfering.

In addition, the annular portion 78 protrudes toward the near side frame 2a in the seat width direction. With such a configuration, when the sensor 30 rotates by the input load, the comparatively highly rigid base end of the annular portion 78 is first pressed in a case where the annular portion of the sensor body 32 is pressed against the inner peripheral surface of the front link center hole 71d as illustrated in FIG. 18. Accordingly, the annular portion is appropriately pressed against the inner peripheral surface of the front link center hole 71d.

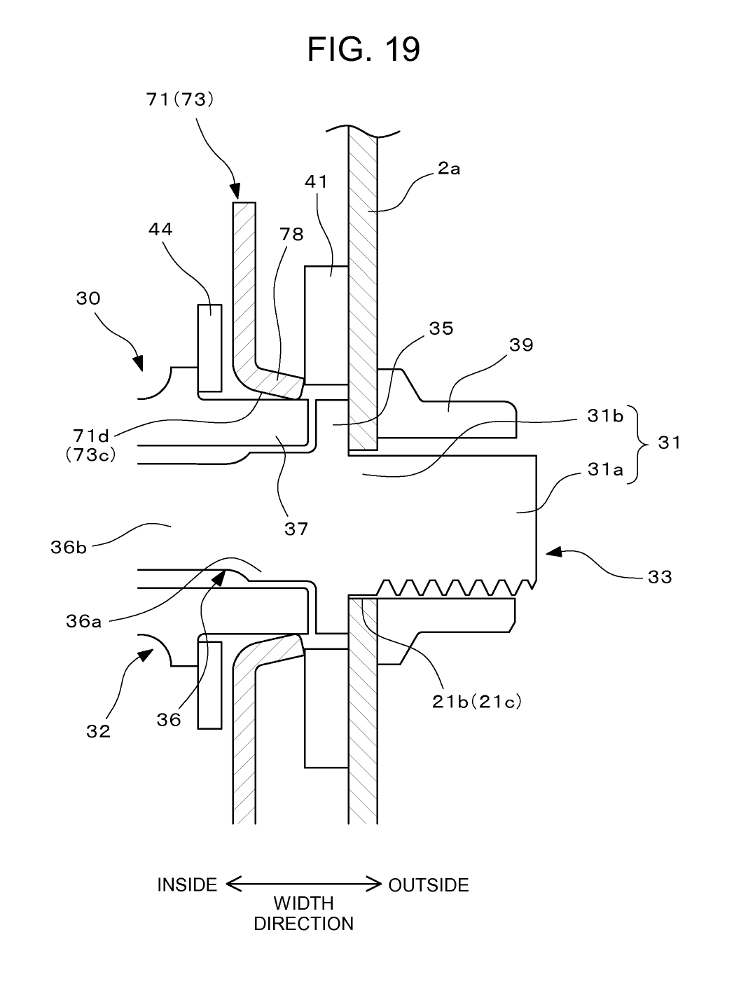

Furthermore, when the annular portion is pressed against the inner peripheral surface of the front link center hole 71d, the load receiving surface 37a of the upper portion of the outer peripheral surface of the annular portion is pressed while being inclined with respect to the center axis of the annular portion. Here, the annular portion is further efficiently pressed against the inner peripheral surface of the front link center hole 71d by increasing the contact area of the load receiving surface 37a with respect to the inner peripheral surface of the front link center hole 71d. For this reason, as illustrated in FIG. 19, the annular portion 78 may be formed in a tapered shape of which the diameter decreases toward the free end, so that the inner peripheral surface of the front link center hole 71d may be formed as a plane that is inclined with respect to the center axis of the annular portion in response to the inclination of the load receiving surface 37a.

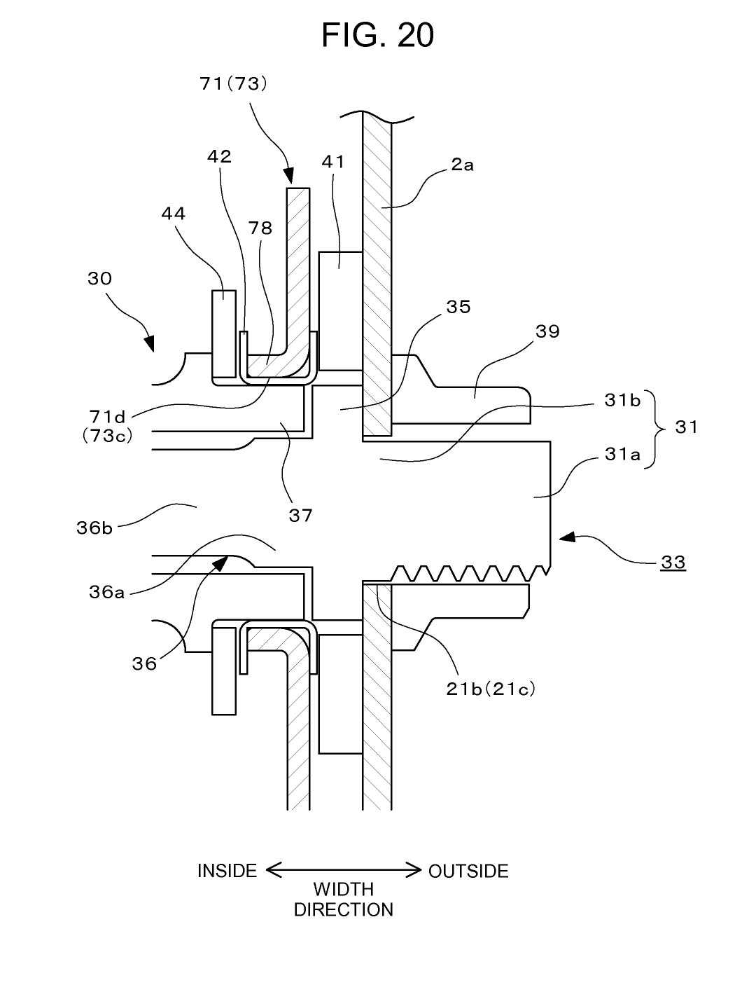

Further, an example has been described in which the annular portion 78 protrudes toward the side frame 2a in the seat width direction, but may protrude toward the opposite side to the side frame 2a as illustrated in FIG. 20. In such a configuration, when the annular portion of the sensor body 32 is pressed against the inner peripheral surface of the front link center hole 71d by the rotation of the sensor 30, the free-end-side end of the annular portion 78 is first pressed against the inner peripheral surface. Accordingly, for example, even when an excessive load is input, the annular portion is pressed against the inner peripheral surface of the front link center hole 71d at the free end side of the annular portion 78. At that time, the free end is bent so that the impact load generated by the collision between the annular portion and the annular portion 78 is released, and hence the excessive load may be absorbed.

Incidentally, in a state where the sensor 30 is supported at a predetermined position, the equal diameter portion 36a of the accommodation shaft portion 36 is disposed at the inner side of the annular portion. Further, the unequal diameter portion 36b is provided in an area adjacent to the equal diameter portion 36a in the accommodation shaft portion 36, and a part of the unequal diameter portion 36b is disposed inside the annular portion. Since the annular portion is disposed at the front link center hole 71d of the driving-side front link 71, a part of the equal diameter portion 36a and the unequal diameter portion 36b are disposed at the front link center hole 71d. With such a configuration, in the annular portion, an entire area of a portion strained inward in the radial direction and contacting the equal diameter portion 36a is surrounded by the inner peripheral surface of the front link center hole 71d of the annular portion 78. Accordingly, in the annular portion, a portion that is strained by the load transmitted thereto contacts the inner peripheral surface of the front link center hole 71d, and hence the load is reliably transmitted.

Further, in Embodiment 7, as in Embodiment 6, each sensor 30 is provided with the spacer 41, the sliding member 42, and the washer 44 as the sensor attachment components 40. Among these, the sliding member 42 is fitted to the front link center hole 71d of the driving-side front link member 71, and forms the sensor body receiving portion along with the inner peripheral surface of the front link center hole 71d. In other words, when the sensor 30 is rotated by the load so that the annular portion as the load detection unit 37 is pressed against the inner peripheral surface of the front link center hole 71d of the driving-side front link 71, the annular portion is pressed against the inner peripheral surface through the sliding member 42.

Then, when the free end of the annular portion is strained inward in the radial direction due to the annular portion contacting the inner peripheral surface of the front link center hole 71d, the sliding member 42 slides on the outer peripheral surface of the annular portion outward in the seat width direction to follow the strain deformation. In this way, since the sliding member 42 slides outward in the seat width direction, the annular portion receives the load at the side frame 2a having the fixed end of the sensor 30. As a result, since the load is stably transmitted to the annular portion, the detection precision is improved.

Furthermore, in Embodiment 7, as not in Embodiment 6, the sliding member 42 is disposed to get astride of the free end of the annular portion in the seat width direction in a state where the sensor 30 is supported at a predetermined position. Accordingly, when the annular portion is pressed against the inner peripheral surface of the front link center hole 71d through the sliding member 42, the annular portion is satisfactorily strained, and hence the load detection precision is improved.

Further, in Embodiment 7, as illustrated in FIG. 16, the one-end-side flange portion 42a and the other-end-side flange portion 42c of the sliding member 42 are formed to be symmetrical to each other. Specifically, two flange portions 42a and 42c substantially have an equal diameter. Accordingly, it is possible to suppress a force, which is exerted on the flange portions 42a and 42c when the annular portion of the sensor body 32 contacts the sliding member 42, from becoming non-uniform between the flange portions 42a and 42c. Further, when the one-end-side flange portion 42a and the other-end-side flange portion 42c are symmetrical to each other, the sliding member 42 may be attached from any end side when the sliding member is attached to the annular portion, and hence the operation of attaching the sliding member 42 may be easily performed.

The attachment of the sliding member 42 will be described. In a state where a substantially cylindrical base material is inserted into the front link center hole 71d of the driving-side front link 71 and both ends of the base material protrude from the front link center hole 71d, caulking is performed on each of both ends of the base material. By the above-described procedure, the sliding member 42 of which both ends are provided with the flange portions 42a and 42c is made, and hence the sliding member 42 is assembled to the driving-side front link member 71. Then, in a state where the sliding member 42 is assembled to the driving-side front link member 71, the outer edge of the free end of the annular portion 78 is located at the inner side of the outer edge of the one-end-side flange portion 42a. Accordingly, at the time point in which the caulking is performed, the one-end-side flange portion 42a may ensure a margin by the protruding amount in relation to the outer edge of the free end of the annular portion 78.

Furthermore, as illustrated in FIG. 17, the one-end-side flange portion 42a of the sliding member 42 contacts the free end of the annular portion 78 without any gap therebetween. The other-end-side flange portion 42c contacts the inner surface of the driving-side front link member 71, but a gap is formed between the driving-side front link member 71 and the corner formed by the other-end-side flange portion 42c and the fitting cylinder portion 42b. As described above, this is caused by the configuration in which the edge of the inner opening of the front link center hole 71d of the driving-side front link member 71 is bent in an R-shape and protrudes toward the side frame 2a to form the annular portion 78. Thus, the other-end-side flange portion 42c is coupled to the portion located at the outer side of the radial direction in relation to the origin when the driving-side front link member 71 is bent in an R-shape.

Further, in Embodiment 7, as illustrated in FIG. 17, the equal diameter portion 36a of the accommodation shaft portion 36 is disposed at the inner position in relation to both ends of the sliding member 42 in the axial direction of the extension shaft portion 31. Accordingly, when the annular portion of the sensor body 32 is pressed against the driving-side link member 71 through the sliding member 42, the equal diameter portion 36a is located at the opposite side to the sliding member 42 with the annular portion interposed therebetween, and hence the load is stably transmitted to the annular portion.

In addition, the sliding member 42 is disposed to get astride of the slit formed between the annular portion and the positioning portion 35 of the sensor body 32 in the axial direction of the extension shaft portion 31. That is, since the slit may be blocked by disposing the sliding member 42 at the outer side of the slit in the radial direction, it is possible to suppress the intrusion of the foreign matter.

Further, a gap (hereinafter, a hollow portion) Vs that is surrounded by the other-end-side flange portion 42c, the fitting cylinder portion 42b, and the R-shaped bent portion of the driving-side front link member 71 in the axial direction of the extension shaft portion 31 reaches the boundary position between the equal diameter portion 36a and the unequal diameter portion 36b of the accommodation shaft portion 36. That is, the hollow portion Vs and the upright wall portion 61 exist at the same position as that of the termination end of the equal diameter portion 36a in the axial direction of the extension shaft portion 31. Further, in the annular portion, a portion located at the same position as that of the termination end of the equal diameter portion 36a in the center axial direction is located at the innermost side in the seat width direction in the pressed area in the inner peripheral surface of the insertion hole 62.

As described above, when the annular portion of the sensor body 32 is pressed against the inner peripheral surface of the front link center hole 71d due to the rotation of the sensor 30, the base-end-side end of the annular portion 78 is first pressed in the inner peripheral surface. At this time, in the annular portion, a portion that is located at the same position as that of the termination end of the equal diameter portion 36a is pressed against the inner peripheral surface of the front link center hole 71d. Here, since the base end of the annular portion 78 is provided with the hollow portion Sv, the impact generated when the annular portion contacts the inner peripheral surface of the front link center hole 71d is absorbed by the hollow portion Sv.

### Other Embodiments

In the above-described embodiments, the load measurement sensor support structure that measures the load applied to the vehicle seat Z has been exemplified as the load measurement sensor support structure. However, the above-described embodiments are merely used to help the comprehension of the present invention, and do not limit the present invention. The present invention may be modified and improved without departing from the spirit of the present invention, and the present invention may, of course, include the equivalent thereof. Further, the above-described material or shape is merely an example for exhibiting the effect of the present invention, and does not limit the present invention.

For example, in the above-described embodiments, a strain sensor that detects and measures the deformation amount of the load detection unit 37 has been exemplified as the sensor 30, but the present invention is not limited thereto. For example, a load measurement sensor may be used which includes a magnet displaced with the deformation of the load detection unit 37 and a hall element facing the magnet. In the load measurement sensor with such a configuration, when the load detection unit 37 is deformed, the magnet is displaced with the deformation, and the hall element measures the displacement amount, thereby measuring the load from the measurement result.

Further, in the above-described embodiments, it is described that the 5-spring 6 is provided as the support spring that supports the cushion member, but the present invention is not limited thereto. For example, a configuration may be employed in which a passenger posture support member such as a pan frame (a sheet-metal member) may be provided instead of the support spring. Even in such a configuration, it is desirable to attach the sensor 30 so that the sensor is separated from the passenger posture support member as much as possible in order to realize the compact size of the vehicle seat Z. Furthermore, as the passenger posture support member, the support spring and the pan frame may be used together or only the pan frame may be used other than the case of using the support spring as in the above-described embodiments.

Further, in the above-described embodiments, it is described that the bushing 43 or the sliding member 42 is provided so that the load is transmitted to the sensor body 32, that is, the load is further appropriately transmitted to the load detection unit 37. Then, the load is applied to the load detection unit 37 through the bushing 43 or the sliding member 42. However, the present invention is not limited thereto. For example, instead of the bushing 43 or the sliding member 42, a member (for example, the side frame 2a or the link members 71 and 73) that presses the sensor 30 may directly press the load detection unit 37 without using the bushing 43 or the sliding member 42. Further, a relay member other than the bushing 43 or the sliding member 42 may be provided inside the load transmission path from the load input portion to the sensor body 32.

Further, in the above-described embodiments, the vehicle seat Z has been exemplified as an example of the seat, but the present invention is not limited thereto. For example, the present invention may be also applied to the other conveyance seat of an airplane, a ship, or the like. Further, the present invention is not limited to the conveyance seat, and may be applied to any seat that requires the load measurement.

### TABLE OF REFERENCE NUMERALS

1 seat back frame
2 seating frame
2a side frame
21a first shaft penetration hole
21b second shaft penetration hole
21c third shaft penetration hole
200 second side frame
200a second lower end wall
200b second center portion connection wall
200c second upper end wall
300 third side frame
300a third lower end wall
300b third center portion connection wall
300c third upper end wall
400 fourth side frame
400a fourth lower end wall
400b fourth center portion connection wall
400c fourth upper end wall
3 back connection pipe
4 front connection pipe
6 S-spring
7 height adjustment mechanism
7a first front rotation shaft
7b first back rotation shaft
7c second front rotation shaft
107c upper spring latching portion
7d second back rotation shaft
7e first link center shaft
10 rail mechanism
11 lower rail
12 upper rail
13 support bracket
15 attachment bracket
17 slide lever
18 bolt
20 front end
21a first shaft penetration hole
21b second shaft penetration hole
21c third shaft penetration hole
30 sensor
31 extension shaft portion
31a male screw portion
31b adjacent portion
31c convex portion
31d convex portion
32 sensor body
33 shaft body
35 positioning portion
36 accommodation shaft portion
36a equal diameter portion
36b unequal diameter portion
37 load detection unit
37a load receiving surface (load input portion)
37b free end
39 nut
40 sensor attachment component
41 spacer
41a circular hole
42 sliding member
42a one-end-side flange portion
42b fitting cylinder portion
42c other-end-side flange portion
42d penetration hole
43 bush
43a cylindrical portion
43b flange portion
43c penetration hole
44 washer
50 bottom wall portion
52 front link attachment portion
52a front insertion hole
53 back link attachment portion
53a back insertion hole
54 outer upright edge
55 other member attachment piece group
71 driving-side front link member
71a driving-side front lower shaft support hole
71b driving-side front connection pipe arrangement hole
71c longitudinal connection link front shaft support hole
71d front link center hole
72 driving-side longitudinal connection link member
72a front link shaft support hole
72b back link shaft support hole
73 driving-side back link member
73a driving-side back lower shaft support hole
73b longitudinal connection link back shaft support hole
73c back link center hole
74 sector gear
74a sector gear center hole
74b link connection hole
74c engagement portion
76 rotational force transmission mechanism
76a rotation operation portion
76b rotation transmission shaft
76c pinion gear
77 track regulation member
77a driving-side loose hole
77b spring engaging piece
78 annular portion
81 driven-side front link member
83 driven-side back link member
101 seat frame
111 lower rail
112 upper rail
271 second driving-side front link member
271a second lower end piece
271b second center portion connection piece
271c second upper end piece
F seat frame
L link mechanism
L1 driving-side link mechanism
L2 driven-side link mechanism
M1 first front sensor arrangement hole (insertion hole on first rotation center)
M2 first back sensor arrangement hole (insertion hole on first rotation center)
M3 second front sensor arrangement hole (insertion hole on second rotation center)
M4 second back sensor arrangement hole (insertion hole on second rotation center)
S seat unit
Sv hollow portion
U spiral spring
U1 spiral portion
U2 outer latching portion
U11 inner spring peripheral portion
U21 hook portion
Z vehicle seat

1. A load measurement sensor support structure:
wherein a seat comprises:
a plurality of attachment members;
a skeleton, which comprises:
a plurality of side frames disposed to be separated from each other in a vehicle width direction; and
a plurality of connection members connecting front and back sides of the side frames of a vehicle,
wherein the skeleton is connected to the plurality of attachment members provided below the plurality of side frames;
a load measurement sensor comprising:
a sensor body that detects a load applied to the seat; and
an extension shaft portion extending from a lateral side of the sensor body;
the load measurement sensor support structure comprising:
a height adjustment mechanism for adjusting a height of the seat that supports the load measurement sensor while the extension shaft portion is located at the lateral side of the sensor body,
wherein:
the height adjustment mechanism includes a link mechanism that connects the side frame to the attachment member and displaces the height of the side frame with respect to the attachment member through the link mechanism; and
the link mechanism has disposed in it at least a part of a load receiving portion of the sensor body of the supported load measurement sensor.

2. The load measurement sensor support structure according to claim 1, wherein the load measurement sensor is rotatably disposed relative to the link mechanism.

3. The load measurement sensor support structure according to claim 1, wherein the link mechanism is constituted by a link member comprising an insertion hole located on its rotation center at which the load measurement sensor is disposed and at which the load receiving portion is disposed.

4. The load measurement sensor support structure according to claim 1, wherein:
the link mechanism includes the attachment members and the link members rotatably journaled to the side frames;
the load measurement sensor is disposed at an insertion hole which is located on a first rotation center and into which a rotation shaft journaled to the link member to rotate the link member with respect to the attachment member is inserted; and
the load receiving portion is disposed at the insertion hole located on the first rotation center.

5. The load measurement sensor support structure according to claim 1, wherein:
the link mechanism includes the attachment members and the link members rotatably journaled to the side frames;
the load measurement sensor is disposed at an insertion hole which is located on a second rotation center and into which a rotation shaft journaled to the link member to rotate the link member with respect to the attachment member is inserted; and
the load receiving portion is disposed at the insertion hole located on the second rotation center.

6. The load measurement sensor support structure according to claim 1, wherein:
the link mechanism comprises:
a front link member that is rotatably journaled to the attachment member and the side frame at the front side of the vehicle; and
a back link member that is rotatably journaled to the attachment member and the side frame at the back side of the vehicle; and
at least one of the front link member and the back link member is formed as a curved member that comprises:
a lower end piece which is rotatably connected to the attachment member and extends toward an upper side of the vehicle;
a center portion connection piece which extends in a curved state from the lower end piece toward the upper side of the vehicle in the vehicle width direction; and
an upper end piece which extends from the center portion connection piece toward the upper side of the vehicle.

7. The load measurement sensor support structure according to claim 1, wherein:
the link mechanism includes the attachment members and the link members rotatably journaled to the side frames; and
the side frame is formed as a curved member that comprises:
a lower end wall which is rotatably connected to an upper end of the link member and extends toward an upper side of the vehicle;
a center portion connection wall which extends in a curved state from the lower end wall toward the upper side of the vehicle in the vehicle width direction; and
an upper end wall which extends from the center portion connection wall toward the upper side of the vehicle.

8. The load measurement sensor support structure according to claim 7, wherein:
the center portion connection wall extends in a curved state from the lower end wall outward and upward in the vehicle width direction; and
the lower end wall is disposed at the inner side of the vehicle in relation to the upper end wall.

9. The load measurement sensor support structure according to claim 1, wherein the link member constituting the link mechanism is provided below the side frame and is disposed at the inner side of the vehicle in relation to a center line extending in the front to back direction of the vehicle of a rail member connected with the attachment member.

10. The load measurement sensor support structure according claim 1, wherein an axis of the connection member and an axis of the extension shaft portion are disposed at different positions.

11. The load measurement sensor support structure according to claim 3, wherein:
the link member constituting the link mechanism is provided with the plurality of insertion holes;
the load measurement sensor is disposed at one of the plurality of insertion holes; and
in the plurality of insertion holes, a diameter of the insertion hole in which the load measurement sensor is disposed is set to be different from a diameter of the insertion hole which is located on the rotation center and in which the load measurement sensor is not disposed.

12. The load measurement sensor support structure according to claim 1, wherein:
the sensor body includes a deformation portion that receives the load at the load receiving portion so as to be bent inward in the radial direction of the extension shaft portion;
the load measurement sensor support structure further comprises:
a load input portion that inputs the load to the load measurement sensor while contacting the load measurement sensor; and
a sensor body receiving portion that presses the load receiving portion when the load measurement sensor is moved by the load input from the load input portion,
wherein:
the sensor body receiving portion is disposed on the insertion hole located on the rotation center of the link member constituting the link mechanism;
the deformation portion is disposed at the insertion hole to face the sensor body receiving portion; and
in a state where the deformation portion is disposed at the insertion hole, the load input portion is separated from the sensor body receiving portion.

13. The load measurement sensor support structure according to claim 4, wherein:
the link member constituting the link mechanism is provided with the plurality of insertion holes;
the load measurement sensor is disposed at one of the plurality of insertion holes; and
in the plurality of insertion holes, a diameter of the insertion hole in which the load measurement sensor is disposed is set to be different from a diameter of the insertion hole which is located on the rotation center and in which the load measurement sensor is not disposed.

14. The load measurement sensor support structure according to claim 5, wherein:
the link member constituting the link mechanism is provided with the plurality of insertion holes;
the load measurement sensor is disposed at one of the plurality of insertion holes; and
in the plurality of insertion holes, a diameter of the insertion hole in which the load measurement sensor is disposed is set to be different from a diameter of the insertion hole which is located on the rotation center and in which the load measurement sensor is not disposed.
